(19) United States
(12) Patent Application Publication
(10) Pub. No.: US 2022/0009141 A1
(43) Pub. Date: Jan. 13, 2022

(54) EXTRUSION OR MOLD PROCESS AND ASSEMBLY FOR FORMING A SINGLE OR MULTI-LAYER MATERIAL HAVING A POLYMERIZED LAYER

(71) Applicant: Neuvotec, LLC, Auburn Hills, MI (US)

(72) Inventors: Miguel A. Linares, Bloomfield Hills, MI (US); Kenneth Williford, Shelby Township, MI (US)

(21) Appl. No.: 17/374,238

(22) Filed: Jul. 13, 2021

Related U.S. Application Data
(60) Provisional application No. 63/050,893, filed on Jul. 13, 2020.
(60) Provisional application No. 63/050,992, filed on Jul. 13, 2020.

(51) Int. Cl. B29C 48/00; B29C 65/00; B29C 48/07; B29C 48/12; B29C 48/18; B29C 48/285

(52) U.S. Cl. CPC B29C 48/0014; B29C 66/83413; B29C 48/2886; B29C 48/12; B29C 48/18; B29C 48/07

(57) ABSTRACT

An assembly for forming a structural, insulating or decorative article as any of a roll, sheet, board or panel and including a width extending die and extruding nozzle for issuing a flowable polymeric material having either of a solid or ribbed cross sectional profile and including any of a polyurethane, a polypropylene or any other polymeric material. At least a pair of opposing and rotating pinch rollers are arranged for receiving therebetween the flowable material. A material roll simultaneously feeds a material layer between the rollers and against the flowable polymer material at a given pressure to cause the polymeric material to fuse and embed within the material layer. The material separate material layer can further include any structural panel, multi-panel or pallet style construction, such including both solid and interiorly hollowed/corrugated constructions.

### CROSS REFERENCE TO RELATED APPLICATIONS

The present application claims priority of U.S. Ser. No. 63/050,893 filed Jul. 13, 2020. The present application also claims priority of U.S. Ser. No. 63/050,992 filed Jul. 13, 2020.

### FIELD OF THE INVENTION

The present invention relates generally to extruding processes for creating structural, insulation or decorative articles. More particularly, the present invention discloses any extrusion or corresponding injection molding process for forming a structural, insulation or decorative article, typically in roll, sheet, board or panel form.

### BACKGROUND OF THE RELEVANT ART

The prior art is documented with examples of structural, insulation or decorative articles which are extruded or otherwise coated with a polymer or other expandable or settable material. One example is depicted in U.S. Pat. No. 9,962,894 to McDonald, which discloses a press for flattening halved bamboo stalks or other workpieces without loss of volume or splintering.

In McDonald, a first mechanical movement is executed by a pushrod drive train, a plurality of spreader bar assemblies press upon the centerline of a workpiece such that the workpiece does not move off of a work surface but is yet not over crushed. Each spreader bar assembly may comprise two spreader bars hingedly attached to a pushrod. The lower end of the pushrod and proximal ends of the spreader bars pin down the workpiece. In a second mechanical movement executed by a crusher bar drive train, the distal ends of the spreader bars are moved outwardly and spread apart the curved walls of the workpiece. In the last phases of a second movement, planar track plates press downwardly upon the workpiece.

US 2019/0111606 to Linares teaches an extruding process and assembly for creating a structural form, and which includes the steps of bundling and conveying a length of an elongated material into an extruder, reshaping a cross section of the bundle in a first stage of the extruder, extruding a material using any combination of heat and pressure around and between the lengths of material, and outputting a finished article having a cross sectional profile in which the materials are structurally supported by the extruded and hardened material. Other steps include an intermediate chilling stage between reshaping and extruding, and for preventing the extruded material from back flowing. The extruded material further includes any of a polymeric or structural foam material and can exhibit any of a rounded, square, rectangular or I beam cross sectional profile.

U.S. Pat. No. 7,147,745, to Slaven, teaches a bamboo building material and process of manufacture. The material includes a plurality of layers each formed of bamboo segments which have been dried and glue coated. The segments are substantially free of outer nodes and husk and inner membrane material prior to application of glue. The longitudinal axes of the segments in each layer are generally parallel to one another, with each layer having segments oriented generally orthogonally with respect to the next adjacent layers thereto. The layers of segments are compressed and bonded together until the glue cures into a single integral structure.

Wellen, U.S. Pat. No. 3,481,818 teaches a laminated sheet structure having an extruded styrene plastic core sheet having fused to both surfaces a biaxial oriented styrene film. The combined film sheets and extruded sheets are forced between a pair of juxtaposed rollers, with the lower roller of the pair having embossed projections pressed into one side of the laminate sheet.

Other references includes such as U.S. Pat. No. 4,504,338 to Ives which teaches the formation of aromatic polymer materials, such as composite foamed thermoplastic resin articles and which includes compressing the mixture to increase its density and remove voids, the preform then being formed in a foamed structure under heat.

Hanson US 2010/0038037 teaches an apparatus for applying a film to a bottom side of an extruded sheet including an extruder assembly and a roll stack assembly for forming the sheet. A first station upstream from the roll stack assembly applies a film to the bottom side of the extruded sheet.

Krumm, U.S. Pat. No. 4,304,622, teaches an apparatus for producing slabs of thermoplastic resin material including a pair of extruders for extruding a half-slab strand of a respective roller assembly. The roller assemblies including final rollers which form a consolidation nip between them in which the two half slabs are bonded together. The half slabs can be formed with longitudinal compartments which can be filled with a foamed synthetic-resin material.

Rawlinson, U.S. Pat. No. 4,329,196, teaches a heat-sensitive, three dimensional thermoplastic layer laminated to a thermoplastic substrate by cooling fusion bonding process. In one variant, a grass-like sheet of low density polyethylene is fusion bonded to a rigid high density polyethylene substrate.

Finally, U.S. Pat. No. 5,779,961, to Teutsch, discloses is a process for making a resin extruded lineal profile structure. The profile extends in an axial direction and has a plurality of continuous discrete fiber bundles radially spaced apart and extending longitudinally substantially along the entire length of the structure. A thermoplastic resin directly contacts the respective fiber bundles along the length thereof.

### SUMMARY OF THE PRESENT INVENTION

The present invention discloses any extrusion or corresponding injection molding process for forming a structural, insulation or decorative article. A width extending injection die is utilized with any arrangement of pinch rollers for forming a polymerized layer (most broadly defined to also include any substance having a molecular structure consisting chiefly or entirely of a large number of similar units bonded together, e.g., many synthetic organic materials used as plastics and resins or natural biopolymers) between outer layers of material not limited to such as fabric, cloth, burlap, mats, scrim, weaving, mesh, muslin or canvas, as well as other outer materials like film, poly spun, vinyl fabric, cloth laminate, cross-linked foam laminate scrim, weaving, mats, or mesh which can include both an exterior finished side and an opposite natural side for facilitating adhering to the central extruded polymerized material.

Other outer ply materials include without limitation carpet, liner or other acoustic dampening material. A still further variant envisions utilizing a width arranged blade for incising a wood veneer layer of a given thickness from a rotating log or stem roll and passing the incised layer through the pinch rollers along with the extruded polymer in order to create a further variant of a structural, insulation or decorative article.

Additional variants include forming a ply material that mixes a wood core, such including any of hardwood/plywood which can be formed in multiple layers. Additional wood core options include any of a medium density fiberboard (MDF), chipboard or oriented strand board (OSB), sawdust with gypsum sheeting plywood, sanded plywood, and other such underlayments. The outer layers applied to the wood core can again include any material previously referenced and not limited to any of acoustic, insulating, waterproofing, fibrous, laminate or other material.

Additional variants include providing the article as multiple extruded polymeric corrugated sheets for forming a durable, lightweight rigid panel or board. Any organic, synthetic, fiber or fabric material not limited to those previously described can be bonded to the multiple ply article. Bonded substrates can also be added to the sheets in a downstream operation or offline in a secondary operation. Additional variants envision a multi-ply article exhibiting a smooth surface sheet, such as which can be bonded to any number of layers of corrugate.

The corrugated articles can be combined with a polymeric extrusion which (with or without separate additional surfacing layers) and produced in either of individual sheets or a finished wound roll. A second pair of pinch rollers can be utilized into the process, such as for reheating (or flash heating) the polymerized material following its initial extrusion and to increase penetration of the polymerized material into the adjoining material layers.

Other variants include mixing a wooden core material (including without limitation hardwood/plywood, medium density fiberboard (MDF), oriented strand board (OSB), sawdust with gypsum sheeting plywood, sanded plywood, and underlayment) along with one or more corrugated intermediate or outer layers.

Other variants include creating a multi-ply panel or board which can be stamped, die-cut or laser cut, such as in order to create a pallet deck and cutout leg materials which are bonded together in any plurality to build up the elevating feet or legs of the pallet. The pallet decks in such an application can be heat stake, forming forklift ramps for engaging the panel or board.

The leg materials in such a variant can be stacked and bonded together with the decks. Use of surface materials such as fibrous layers can provide for efficient and inexpensive bonding with the polymerized flowable material, as well as providing a non slip surfacing characteristic with high surface friction, similar to wood. The pallet can also be produced utilizing in part or entirely any recycled materials.

The pallet construction created can be nest-able or ventilated along with providing the optimal characteristics of light weight and durability and of utilizing the stamped, die-cut or laser cut cutout portions to build up the elevating feet/legs of the pallet. Other features and characteristics of the pallet include providing the pallet with fire retardant capabilities, minimizing thermal expansion/contraction of the polymer/composite matrix, along with varying stiffness, colors, and anti-microbial properties.

In instances when there is no need for adhesive for coating the outer layers a molecular bonding is normally created with amorphous and semi-crystalline laminates. Wetting is not the only factor to consider when trying to achieve good adhesion. The morphology/structure of the plastic also influences adhesion. If the structure of the polymer is amorphous, the molecules at the surface tend to be loosely packed; in a semi-crystalline configuration, the molecules at the surface tend to be more tightly packed.

Amorphous materials are generally easier to adhere to than substrates with moderate or high degrees of crystallinity. The temperature of a plastic part also can influence the ability to achieve good adhesion. Applying heat before coating a plastic part can soften the surface and increase surface energy thus making the part easier to coat. The softer surface may also allow for some penetration of the coating into the substrate, creating greater adhesion through physical entanglement of the coating and substrate polymers.

Additional features include the total or partial use of recycled or reclaimed polymers. Other additional features include the resultant article produced according to any extruded or injection molding process depicting an outer fibrous material which can be treated with a variety of additives/fillers for providing fire retardant capabilities, minimize the thermal expansion/contraction of the polymer/composite matrix, along with varying stiffness, colors, anti-microbial properties or post production wolmanizing/pressure treating operations, the fibrous material (such including jute/burlap, hemp, ramie, bamboo, cotton, linen, silk, sisal, piassava, alfa, bagasse, banana, pineapple, acacia, coconut, kenaf, wool, abaca, nettle, coir, cashmere, biuriti, ramie, and others) further being either pressed deeply into the polymer by the pinch rollers in order to create a mild organic texture or, alternatively, lightly pressed for producing a more natural finish. A plurality of previously and individually extruded components can also be stacked and subsequently pressure and heat treated to bond them together in order to provide additional structural, insulation or decorative applications not limited to gluing, nailing, screwing, stapling, routing, cutting or drilling. Such additives/fillers may without limitation include organic/inorganic waste.

Additional variants include providing multiple extruded polymeric sheets which can be bonded to any substrate material, such as for example plastic extrusions forming a durable, lightweight rigid panel or board. Any organic, synthetic, fiber or fabric material not limited to those previously described can be bonded to the multiple ply article. Bonded substrates can also be added to the sheets in a downstream operation or offline in a secondary operation. Additional variants envision a multi-ply article exhibiting a smooth surface sheet, such as which can be bonded to any number of layers of corrugate material.

The corrugated articles can be combined with a polymeric extrusion which (with or without separate additional surfacing layers) and produced in either of individual sheets or a finished wound roll. A second pair of pinch rollers can be utilized into the process, such as for reheating (or flash heating) the polymerized material following its initial extrusion and to increase penetration of the polymerized material into the adjoining material layers.

Other variants include mixing a wooden core material (including without limitation hardwood/plywood, medium density fiberboard (MDF), oriented strand board (OSB), sawdust with gypsum sheeting plywood, sanded plywood, and underlayment) along with one or more corrugated intermediate or outer layers. This can include the use of corrugated plastics (also known as Corriboard), which are also known under the tradenames of Cartonplast, Polyflute, AkyBoard, Bubble-X, InterPro, ThermHex, Coroplast, FlutePlast, InterPro, Proplex, Correx, PCORR, Cor-X, Twinplast Corriflute or Corflute, and refers to a wide range of extruded twin wall plastic sheet products produced from different polymers/resins with a similar makeup to corrugated fiberboard, these being a light-weight and tough material which can be fairly easily cut.

At regular temperatures, most oils, solvents and water have no effect, allowing it to perform under adverse weather conditions or as a product component exposed to harsh chemicals. Standard sheets can be modified with additives, which are melt-blended into the sheet to meet specific needs of the end user. Special products may require additives for addressing any or all of ultra-violet protection, anti-static, flame retardant, custom colors, corrosive inhibitors, and static-dissipative, among others.

Other three-dimensional structures that include a honeycomb profile are made up of cell structures that are round rather than hexagonal, more closely resembling honeycomb structures that exist in nature. The round cell structure give the resulting cell matrix three orientations versus the two orientations in hexagonal matrices. Alternatively, bubble corrugated sheet or air bubble corrugated sheets provide other alternatives.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 illustrates an extrusion process for forming a multi-layer article including a polymer extruded material not limited to a polyurethane or polypropylene which is passed through an arrangement of pinch rollers along with a coarse material such as a fabric, cloth, burlap, mats, scrim, weaving, mesh, muslin or canvas for pressing the material into the molten polymer by the rollers and without the need for separate adhesives for producing a resulting sheet, panel or board with a desired combination of stiffness, smooth polymer and fibrous organic qualities according to one embodiment of the present inventions;

FIG. 2 is an illustration similar to FIG. 1 of a further variant of the present invention in which outer material layers are applied to both sides of a central polymerized extruded material;

FIG. 3 is a similar illustration to FIG. 2, again depicting an upper outer material layer applied to the central polymerized extruded material, with the resultant article being wound in a rolled or coil form;

FIG. 4 is an illustration of a resultant article produced according to any extruded or injection molding process according to the present invention and depicting an outer fibrous material which can be treated with a variety of additives/fillers for providing fire retardant capabilities, minimizing the thermal expansion/contraction of the polymer/composite matrix, along with varying stiffness, colors, anti-microbial properties or post production wolmanizing/pressure treating operations, the fibrous material further being either pressed deeply into the polymer by the pinch rollers in order to create a mild organic texture or, alternatively, lightly pressed for producing a more natural finish, with such additives/fillers may include organic/inorganic waste material;

FIG. 5 is a variant of FIG. 3 and depicts a post formation operation in which a plurality of individual extruded components are stacked and subsequently pressure and heat treated to bond them together in order to provide additional structural, insulation or decorative applications not limited to gluing, nailing, screwing, stapling, routing, cutting, sawing or drilling;

FIG. 6 is variant of an extruding process similar to as shown previously in FIG. 2 and substituting the upper ply material with any of a film, poly spun, vinyl fabric, cloth, laminate, crosslinked foam laminate, scrim, weaving, mats, mesh, pulp or paper;

FIG. 7 is an illustration similar to that shown in FIG. 4 of a resultant article produced according to the extrusion process of FIG. 6 and depicting an exposed finished side of the film, poly spun, vinyl, fabric, cloth, laminate, crosslinked foam laminate, scrim, weaving, mats, mesh, crosslinked foam laminate, pulp or paper material in combination with an opposite adhering side for securing to the polymerized extruded material;

FIG. 8 is a further alternate representation to that depicted in each of FIGS. 2 and 6 and depicting the upper ply material as any of a carpet, liner or other acoustic material;

FIG. 9 is an illustration similar to FIGS. 4 and 7 of a resultant article produced according to the extrusion process of FIG. 8 and depicting each of a finished side and a natural fiber backed side;

FIG. 10 is a still further alternate representation to that depicted in each of FIGS. 2, 6 and 8 and illustrating a further variant utilizing a width arranged blade for incising a wood veneer layer of a given thickness from a rotating log or stem roll and passing the incised layer through the pinch rollers along with the extruded polymer in order to create a further variant of a structural, insulation or decorative article which can be provided in either sheet or roll form;

FIG. 11 is an illustration similar to FIG. 10 and depicting an alternate roller feeding orientation of the rotating log or stem roll for creating the article which again can be provided in either sheet or roll form;

FIG. 12 is an illustration of a further variant of an extrusion process as compared to FIG. 1, for producing a continuous combination fibrous/polymer sheet and which can be either sectioned into individual sheets or wound into a roll/coil form;

FIG. 13 illustrates a further variant of an extrusion process for forming a combination fibrous or other coarse material and polymer shape article, and which can be produced in either of sheet or roll/coil form and showing any outer layer material applied onto the polymer extrusion downstream from the die;

FIG. 14 is an enlarged view of the extrusion die according to FIG. 13 and showing the heated upper roller in FIG. 13 providing for flash melting and penetration of the previously extruded polymer into the fibrous or burlap layer;

FIG. 15 is an illustration of a further embodiment of the present invention and depicting each of an outer applied layer along with an inner applied secondary layer, such further not limited to a vinyl or other heat-sensitive material, and in which the second roll is applied from an inner positioned location for feeding the secondary material simultaneous with the extrusion step combining the polymer and the first applied ply material;

FIG. 16 is a rotated view of the process depicted in FIG. 15 and which illustrates an alternate application for producing a polymer extruded, sheet, board or panel article having an outer fibrous or other material backed non-finished (B side) surface in combination with a finished (A side) surface and which can be produced into rolls or cut into desired dimensioned sheets;

FIG. 17 is an illustration of a structural article created by any process described herein and forming a wood core from a plurality of sheets of wood material such as bonded to plywood, and as further illustrated showing an upper fibrous layer and a lower weatherproof material;

FIG. 18 is a similar illustration to FIG. 17 and depicting an alternate wood core formed from any of medium density fiberboard (MDF), oriented strand board (OSB), sawdust with gypsum sheeting plywood, sanded plywood, and other such underlayments;

FIG. 19 illustrates an extrusion process for forming a multi-layer article including a cross die extruded polymer material exhibiting a honeycombed or other interiorly hollowed configuration not limited to a polyurethane, polyethylene or polypropylene, the extruded material being passed through an arrangement of pinch rollers along with a coarse material such as a fabric, cloth, burlap, mats, scrim, weaving, mesh, muslin or canvas for pressing the material into the polymer by the rollers and without the need for separate adhesives for producing a resulting sheet with a desired combination of stiffness, smooth polymer and fibrous organic qualities according to one embodiment of the present inventions;

FIG. 20 is an enlarged illustration of the three dimensional sheet material produced according to the process and assembly of FIG. 19 and better showing the coarse outer layers of material applied to both sides of a central polymerized extruded material exhibiting a hollowed interior profile such as defined by reinforcing rib supports which can either be formed through the design of the cross head extrusion die or through the use of a separate pre-extrusion process for preforming the polymerized material to exhibit the desired interior cross sectional hollow profile in order to provide the finished panel with variable thicknesses along with greater strength and lighter weight;

FIG. 21 is an illustration similar to FIG. 20 and showing a substitute upper ply material provided as any of a carpet, liner, or other acoustic material;

FIG. 22 is an illustration showing a substitute upper play material provided as any of a film, poly spun, vinyl, fabric, cloth laminate, cross-linked foam laminate, scrim, weaving, mats or mesh or wallpaper such as depicting an exposed finished side of the vinyl fabric material in combination with an opposite adhering side for securing to such as a polymerized extruded material;

FIG. 23 is a variant of FIG. 20 and depicting a post formation operation in which a plurality of individual extruded components are stacked and subsequently pressure and heat treated to bond them together in order to provide additional structural, insulation or decorative applications and associated fastening techniques not limited to gluing, nailing, screwing, stapling, saw cutting or drilling;

FIG. 24 is an illustration of an article produced from multiple individual extruded polymeric corrugated sheets, further defined as having hollowed interior locations, for forming a durable, lightweight rigid panel or board, and including any type of sheet bonded to the substrate panel or board and for use in any type of laminated or non-laminated sheeting, flooring, walls, ceiling, decorative applications, adhesive bonding, welding or mechanical fastening;

FIG. 25 is an illustration of a further article similar to FIG. 24, again produced from multiple individual extruded corrugated or otherwise three dimensional sheets with hollow interior locations, and including any organic, synthetic, fiber or fabric materials not limited to those previously described bonded to any of the individual extruded plies, such further including bonded substrates which can be added in either offline or secondary operations and for use in any type of laminated or non-laminated sheeting, flooring, walls, ceiling, decorative applications, adhesive bonding, welding or mechanical fastening;

FIG. 26 is an illustration of a further structural multi-ply article including corrugated extruded plastic/polymeric sheets, such as which can be bonded to any number of layers of corrugate and for use in any of sheeting, flooring, walls, ceiling, decorative applications, adhesive bonding, welding or mechanical fastening, and additionally contemplating a ply material which mixes a wood core including any hardwood/plywood, medium density fiberboard (MDF), oriented strand board (OSB), sawdust with gypsum, sheeting plywood, sanded plywood, or other underlayments, and combined with one or more corrugated outer layers to create a sandwich composite article;

FIG. 27 illustrates an extrusion process for producing a continuous combination fibrous/polymer sheet and which can be either sectioned into individual sheets or wound into a roll/coil form, such article also envisioning any of dual or single lamination techniques associated with the feeding at the nip of the extrusion die;

FIG. 28 presents a further variant of an extrusion process for producing a continuous combination fibrous/polymer sheet which can be either sectioned into individual sheets or wound into a roll/col form, such article also envisioning any of dual or single lamination techniques associated with the feeding at a downline location along with the use of additional lamination pinch rolls associated with a reheat (or flash heat) post extrusion operation;

FIG. 29 is a still further alternate representation of a process for forming any structural, insulation or decorative article and including a width arranged blade for incising a wood veneer layer of a given thickness from a rotating log or stem roll and passing the incised layer through a pair of pinch rollers along with the extruded polymer;

FIG. 30 is an enlarged view of the extrusion die according to either of FIGS. 28-29 and depicting the die extending into a roll area defined between the pinch rollers, facilitating the penetration of the burlap or other non-limiting fibrous materials into the polymer without excessive compression/crushing of the extruded shape;

FIG. 31 presents an enlarged illustration of the interface between the second pair of pinch die rollers shown in FIG. 29, such in combination with heating of the upper roller for providing flash melting of the previously extruded layer and penetration into the burlap or other fibrous layer not limited to any of those previously described;

FIG. 32 is an illustration of a multi-ply panel or board which can be stamped, die-cut or laser cut, such as in order to create a pallet deck and cutout leg materials which are bonded together in any plurality to build up the elevating feet or legs of the pallet;

FIG. 33 is an illustration of a variant of pallet deck which can be heat staked, forming forklift ramps for engaging the panel or board; and

FIG. 34 is a further illustration of a stamped, die-cut or laser cut pallet and which illustrates the leg materials stacked and bonded together with the decks shown in FIG. 32, with the use of surface materials such as fibrous layers optionally provided for efficient and inexpensive bonding with the polymerized flowable material, as well as providing a non slip surfacing characteristic with high surface friction similar to wood, the pallet can also being produced utilizing in part or entirely any recycled materials, the pallet construction created being nest-able or ventilated along with providing the optimal characteristics of light weight and durability and of utilizing the stamped, die-cut or laser cut cutout portions to build up the elevating feet/legs of the pallet, with other features and characteristics of the pallet including providing the pallet with fire retardant capabilities, minimizing thermal expansion/contraction of the polymer/composite matrix, along with varying stiffness, colors, and anti-microbial properties.

### DETAILED DESCRIPTION OF THE PREFERRED EMBODIMENTS

With reference to the attached illustrations, the present invention discloses a number of related embodiments primarily directed to a continuous extruding process and assembly for creating structural, insulation or decorative articles, typically in an elongated panel or board or rigid sheet form. As will be further described, the present invention envisions a variety of formation techniques and applications for creating the structural, insulation or decorative articles, such exhibiting a variety of different properties. Without limitation, this can also include substituting injection molding or other polymerized formation applications in lieu of the extrusion formation processes described and illustrated herein, and in order to create an article exhibiting the desired properties.

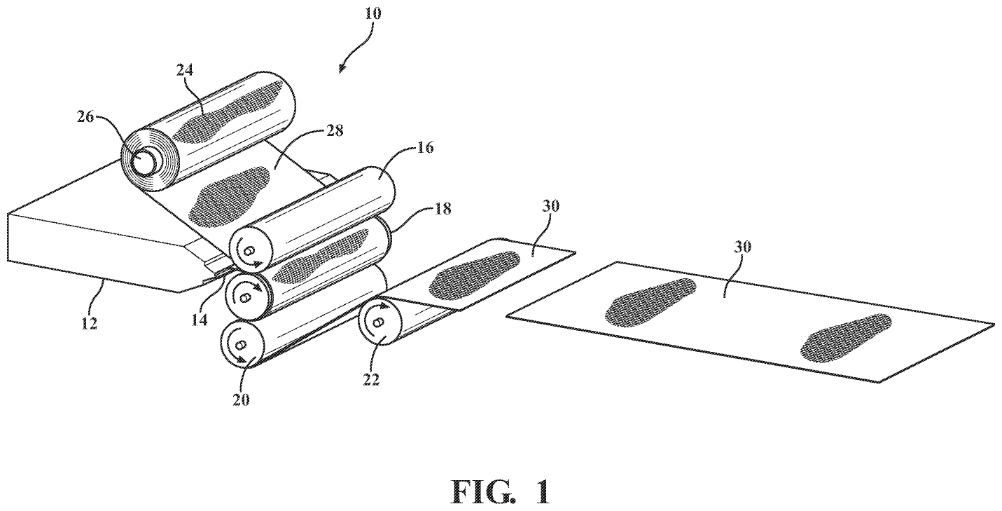

With reference to FIG. 1, an illustration is generally referenced at 10 of an extrusion process for forming a multi-layer article. This includes the provision of a width extending die 12 having a narrowed forward nozzle 14 and such as which can be part of a cross head die arrangement which is supplied by a separate source of a heated and flowable polymer not limited to a polyurethane, polypropylene or other composite material, and which can further include a suitable network of conduits lines and heaters for preparing and delivering the extruded material in a desired continuous and nozzle injection profile. Beyond that shown, it is also understood and envisioned that the extrusion die nozzle 14 can be extended or otherwise reconfigured to issue the heated and flowable polymer material.

An arrangement of individual and spindle supported rotating pinch rollers are depicted and include a first pair of upper 16 and lower 18 rollers which are positioned forwardly and in relatively close proximity to the width extending extrusion nozzle 14 of the cross head injection die. A further reverse direction roller 20 is located below the lower roller 18 and redirects the extruded article to a further downstream roller 22. Although not shown, it is understood that the rollers are individually or collectively either rotatably driven in a given clockwise or counter-clockwise direction or are freely rotatable, such rotatably driving structure being known in the relevant art.

A roll of a further ply material is shown at 24 and is likewise spindle mounted, at 26, at a location approximate the orientation of the cross head die 12 and forward extrusion nozzle 14. As shown, the width of an unwound sheet, panel or board 28 is approximate to that of the die extrusion nozzle 14 and so that, in combination with the appropriately sized and positioned rollers 16, 18, 20 and 22, provides for formation of a structural, insulation or decorative article exhibiting the desired width and cross sectional properties. This can include the material properties of the flowable polymerized material being calibrated through the use of thermocouples and site specific heaters (not shown) to allow the die 12 and nozzle 14 to extrude a steady sheet, panel or board of material which is sufficiently solidified to maintain its dimensional characteristics while being pressed by the rollers in order to fuse and embed within the matrix composition of the unwound sheet, panel or board 28 and to solidify into a structural, insulation or decorative integrated sheet, panel or board product having desired properties of rigidity.

The ply material 24 can include any coarse material such as a fabric, cloth, burlap, mats, scrim, weaving, mesh, muslin or canvas for pressing the material into the molten polymer by the stacked tier of rollers 16, 18 and 22, with roller 16 rotating counter clockwise as shown and opposing roller 18 rotating clockwise a close separation distance to force the molten extruded polymer into the unwound ply sheet 28. The roller 20 is likewise in contact with the underside of the roller 18 and rotates counter clockwise to provide additional press formation of the extruded material into the sheet, panel or board 28 while redirecting the combined material to the downstream located (take-up) roller 22.

In this manner, the extrusion process creates a structural, insulation or decorative article without the need for separate adhesives for producing a resulting sheet, panel or board (see as shown as individual incised sections 30 which can occur following the take up roller 22 through the use of any suitable machine press or the like), such exhibiting any desired combination of stiffness, smooth polymer and fibrous organic qualities.

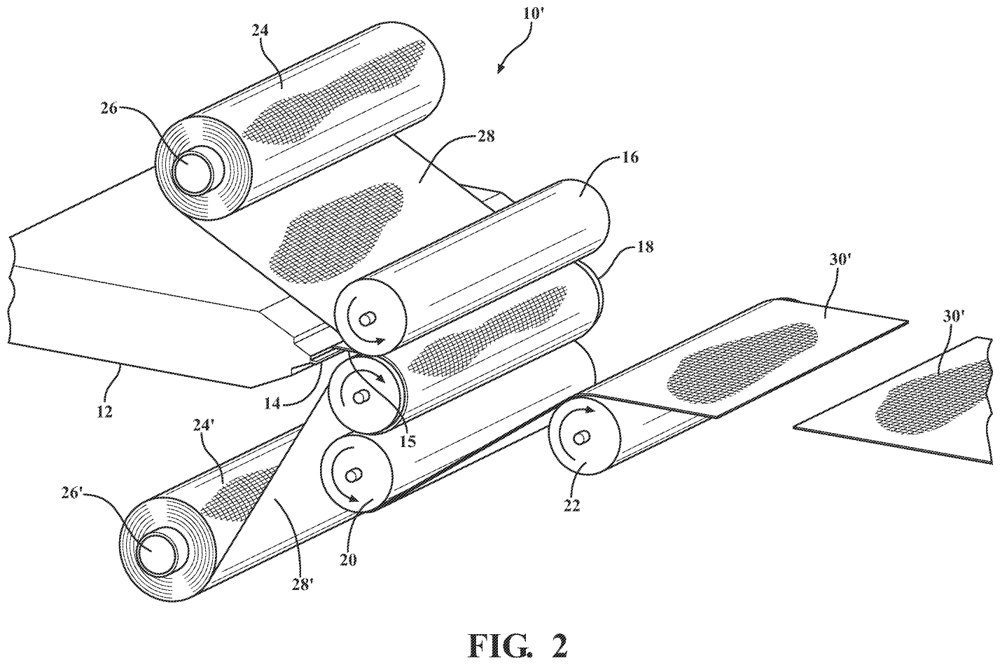

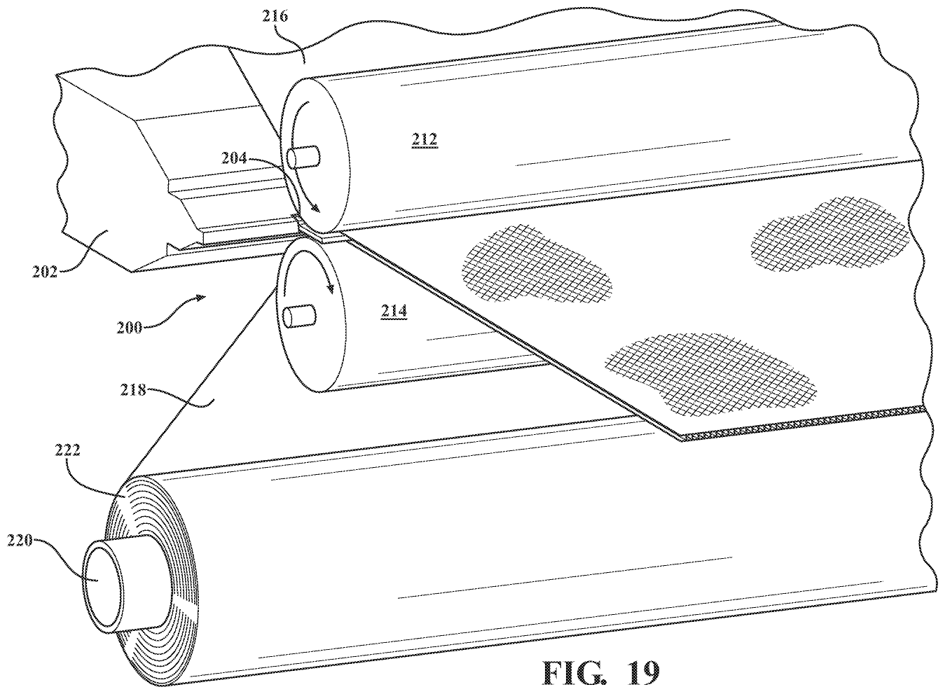

FIG. 2 is an illustration similar to FIG. 1 of a further variant 10′ of the present invention in which a pair of upper (again at 24) and lower (at 24′) spindle supported (at 26 and 26′) ply material rolls are provided both above and below the extrusion die 12 and nozzle 14 in order to unreel a pair of outer material layers (again depicted at 28 and as further represented at 28′) applied simultaneously to both sides of the central polymerized extruded material (this being better depicted as a continuous or solid extruded layer 15 of any type of polyurethane or polypropylene material) and as represented throughout the several views (further reference to the alternate variants of FIG. 19 et seq. describing non-solid cross sectional depictions of polymeric extruded material not limited to those exhibiting any ribbed or otherwise hollowed interior configuration). A similar arrangement of die rollers is again provided at 16, 18, 20 and 22 for the creation of post operation incised sheets, panels or boards 30′ of an eventual article in which the coarser material layers 28/28′ is applied to both sides of the central extruded material 15.

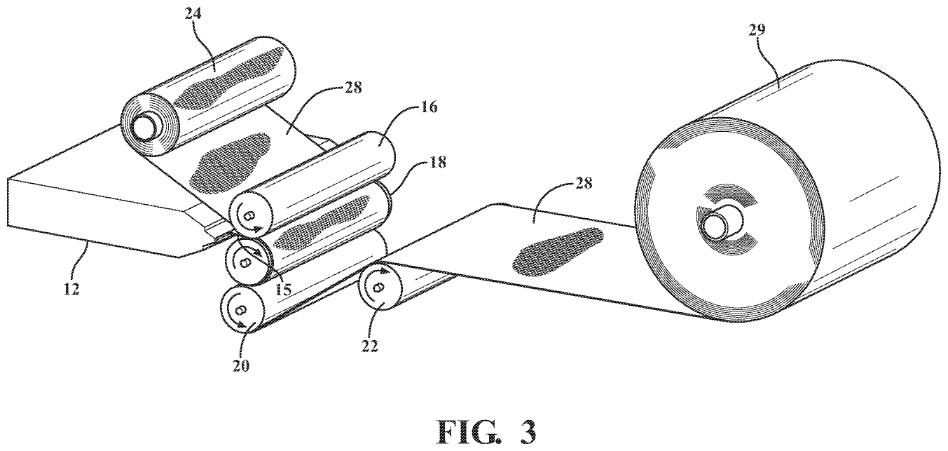

FIG. 3 is a similar illustration to FIG. 2, again depicting a single upper outer material layer 28, as in FIG. 1, applied to the central polymerized extruded material 15, with the resultant article being wound in a rolled or coil form as further depicted at 29. The configuration of the rollers 16, 18, 20 and 22 is otherwise as shown in FIG. 2.

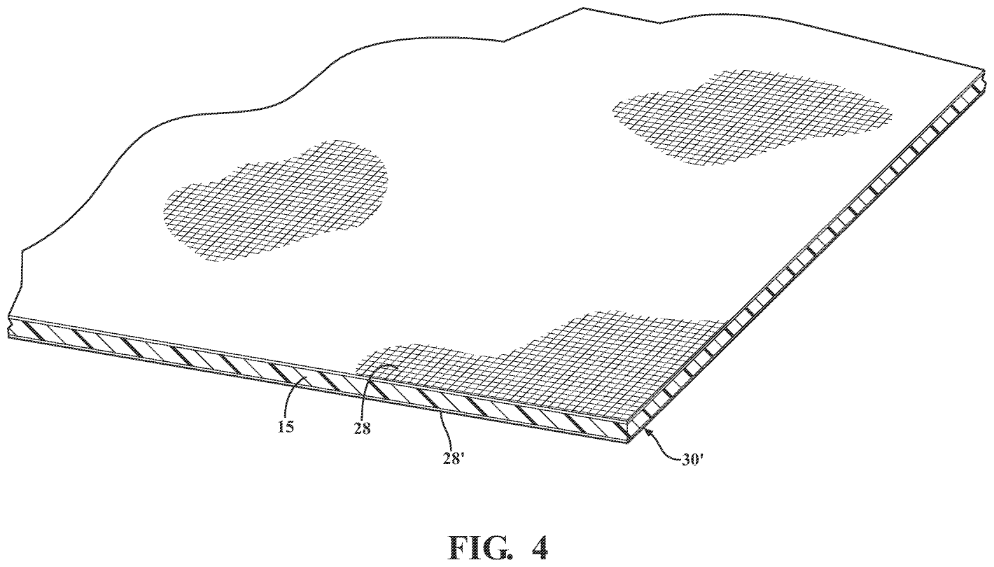

FIG. 4 is an illustration of the resultant article, as referenced at 30′, produced according to any extrusion or like molding process according to the present invention and depicting the layers of outer fibrous material (again at 28 and 28′), which can include a variety of organic or synthetic materials and which can be treated with additives/fillers or other agents for providing fire retardant capabilities, minimize the thermal expansion/contraction of the polymer/composite matrix, along with the use of blowing agents/chemical foaming agents, varying stiffness, colors, anti-microbial properties or post production wolmanizing/pressure treating operations. As further described, the spacing and construction of the stacked and opposing arrayed rollers 16/18/20 is such that the fibrous material layers 28/28′ are either pressed deeply into the extruded polymer 15 by the pinch rollers in order to create a mild organic texture or, alternatively, the positioning of the rollers can be adjustable for lightly pressing the polymer for producing a more natural finish.

The present invention also envisions the use of any other polymers and/or other additives/fillers or components or the like incorporated into the extruded composition 15, such envisioned to provide a range of qualities associated with one or more of stiffness, flexibility, weight, and the like. It is further envisioned that the article 30′ can be produced from entirely recyclable materials and can in turn be recyclable once it's given use application is exhausted.

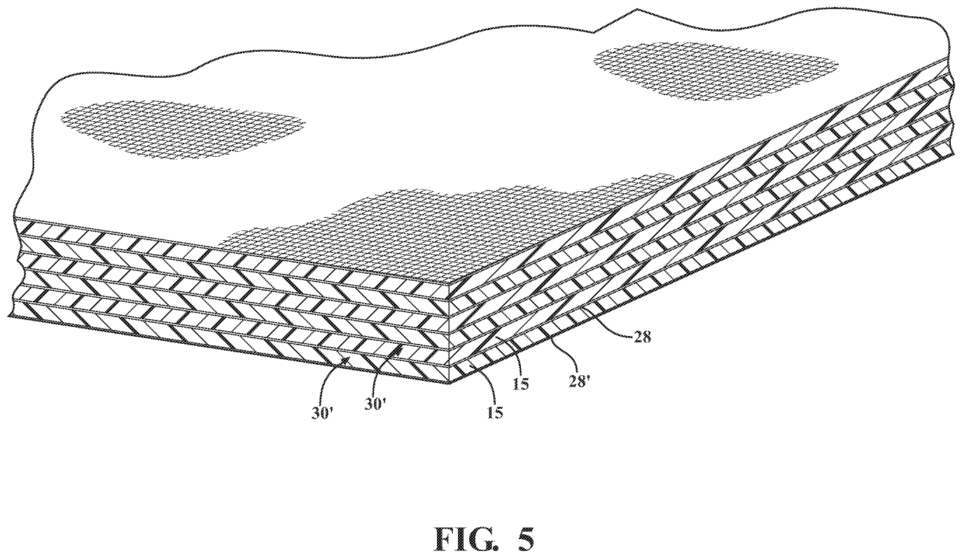

FIG. 5 is a variant of FIG. 4 and depicts a post formation operation in which a plurality of individual extruded components 30′ are stacked and subsequently pressure and heat treated to bond them together in order to provide additional structural, insulation or decorative applications, and in which the steps of fabricating and securing the structural panel or board is not limited to any of gluing, nailing, screwing, stapling, routing, cutting, sawing or drilling. As is known, polymer compositions are typically difficult or expensive to bond with other materials. The post formation pressure bonding step takes advantage of the ability of the extruded material layers 15 to be forced (or bleed through) the alternating outer canvas or other coarser layers 28 and 28′ during the subsequent pressure formation operation and in order to create a board material having a given material thickness suitable for providing many of the qualities similar to wood such that it can be easily and inexpensively fabricated by any of gluing, nailing, screwing, stapling, routing, cutting, sawing, or drilling in a similar fashion as conventional wooden members.

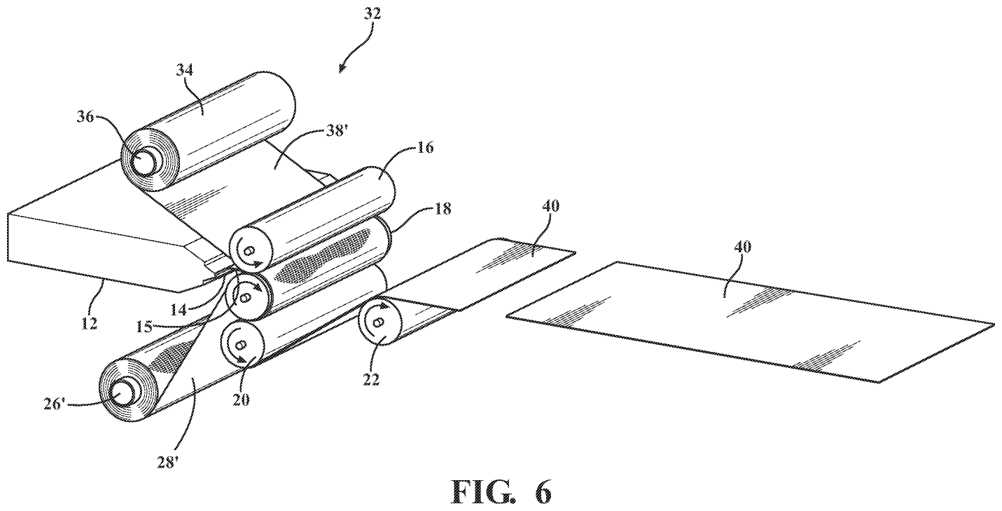

Proceeding to FIG. 6, a variant is shown at 32 of an extruding process similar to as shown previously in FIG. 2 and substituting the previously depicted upper layer 24 with an upper roll material 34 including any of a film or film substrate, vent, fabric, cloth, laminate, cross-linked foam laminate, scrim, weaving, mats, mesh, pulp or paper roll which is spindle supported at 36 similar to as previously described and so that an unwound ply 38′ from the roll 34 is fed into the rollers 16/18 in forced compression fashion opposite the coarser layer, as also previously shown at 28′, and in order to create a completed board or article 40 such as is shown in a post-formation sectioning operation.

A list of films/textiles/laminates can include, without limitation, non-woven polymers (polyester, polypropylene, rayon, or other blends), unbroken loop polymers (nylon, polyester), brushed polyester, woven or weft insert scrim, poly/cotton woven materials. Other films include any of thermoplastic polymers, flexible PVC, rigid PVC, polypropylene (PP, homopolymer, copolymer), polyethylene (LDPE, LLDPE, HDPE), olefin elastomers (TPO, POE, Metallocene), ethylene vinyl acetate (EVA), polyurethane (Ether or Ester) TPU, polyurethane (aliphatic) TPU, acrylic (impact modified) PMMA, acrylic (UV screening) PMMA, acrylonitrile butadiene styrene (ABS), bio-based (poly lactic acid) PLA, co-polyester PETG, PCTG, polyester elastomer (COPE), and polycarbonate (PC) and Fiberglass Reinforced Plastic (FRP). Additional film substrates can include, again without limitation, any of PVC, PE, PP, EVA or TPU.

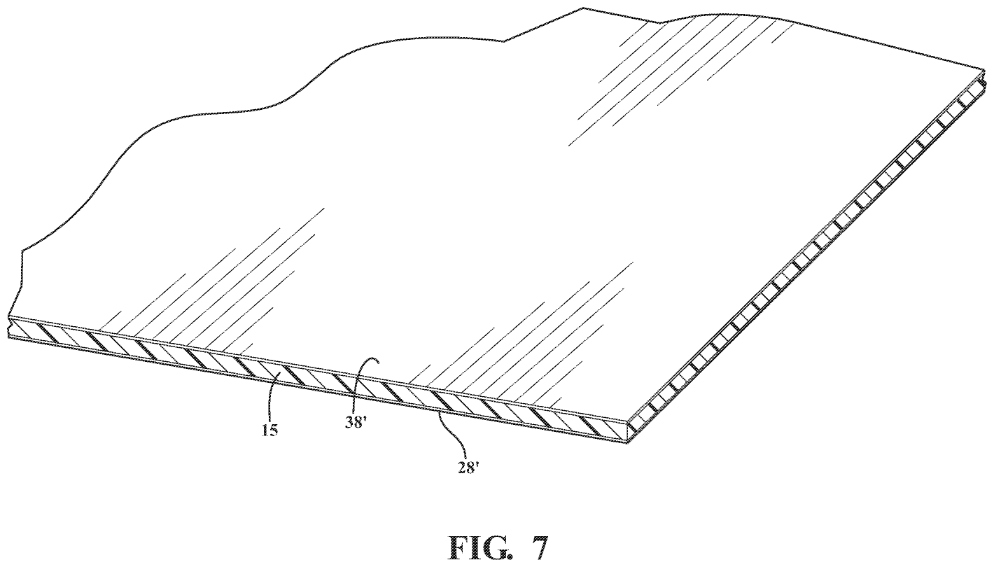

The resultant sheet, panel or board article 40 is produced according to this process and is again further shown in FIG. 7, this depicting an exposed finished side of the upper material layer 38′ in combination with an opposite adhering side of the lower coarser layer 28′ for securing to the polymerized extruded material 15, this again facilitated by pressure or forced bleed-through of the polymerized extrusion into the coarser layer and without the requirement for using adhesives or initial pressure application processes.

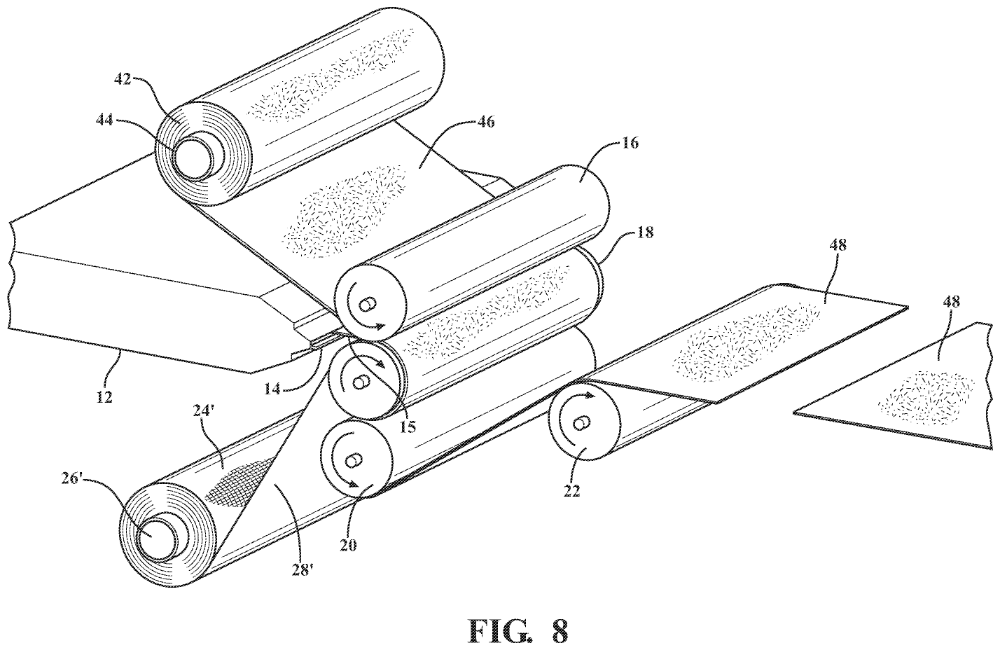

FIG. 8 provides a further alternate representation to that depicted in each of FIGS. 2 and 6 and depicting the upper ply material as roll 42 supported by a spindle 44 and from which is unwound any of a carpet, liner or other acoustic ply material 46 for formation of a structural, insulation or decorative article 48 in a similar fashion as previously described. FIG. 8 is an illustration similar to FIGS. 4 and 7 of the resultant article 48 produced according to the extrusion process of FIG. 7 and depicting each of a finished side (carpet layer 46) and natural fiber backed side (underside layer 28′) secured to the middle extruded layer 15.

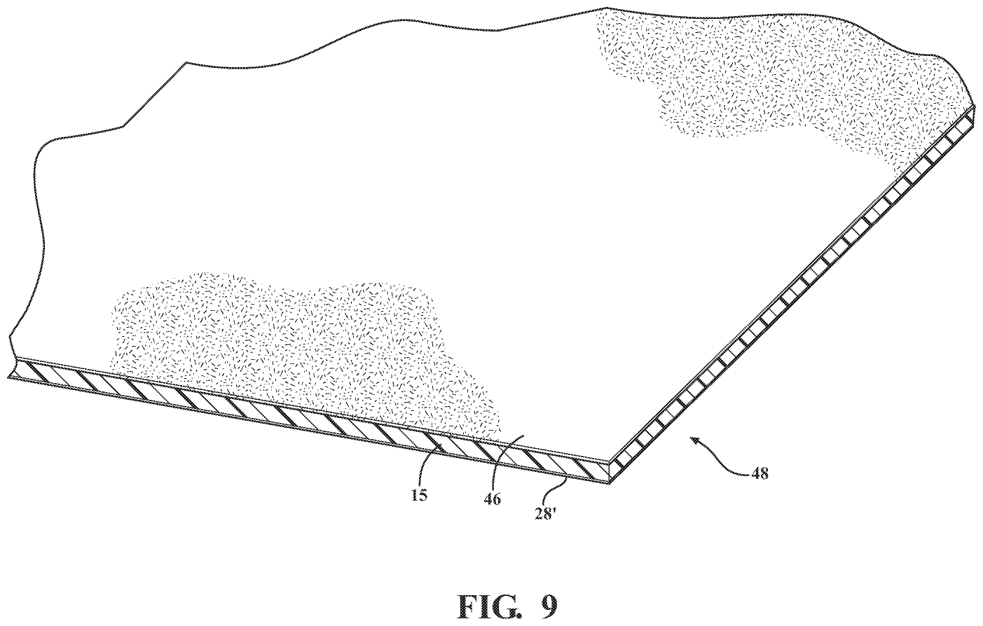

FIG. 9 is an illustration, generally at 48, similar to FIGS. 4 and 7 of a resultant article produced according to the extrusion process of FIG. 8 and depicting each of a finished side (see acoustic ply material 46) and natural fiber backed material 28′ defining an unfinished side, and between which is sandwiched the middle extruded material 15. The finished acoustic ply (carpet) material 46 provides the article with a natural look and feel, this in combination with the natural fiber underside backing 28′ for providing effective adherence between the layers in response only to the exerted pressure of the rollers 16/18/20 which force the polymerized extruded layer into the gaps or crevices within the outer layers 46 and 28′ for providing effective bonding and without the need for separate adhesives or any post formation compression operations.

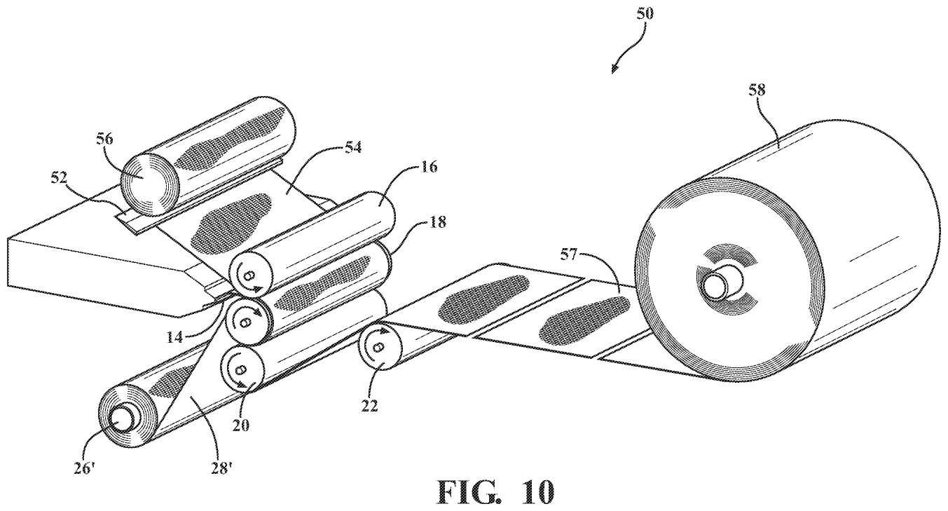

Referring to FIG. 10, illustrated is a still further alternate representation is depicted at 50 (again in comparison to each of FIGS. 2, 6 and 8) and illustrating a further variant utilizing a width arranged blade 52 for incising a wood veneer layer 54 of a given thickness from a rotating log or stem roll 56 (such as which can be spindle mounted in similar fashion as with the preceding described variants). The blade 52 can be affixed to a numerical controller (not shown) of some type and so that inward displacement of the blade is calibrated to the progressive removal of material from the continuously wound log or roll 56 and in order to maintain the integrity and thickness of the unwound sheet, panel or board (see also individual sectioned lengths at 57). The incised layer of unwound material 54 is illustrated being passed through a single pair of pinch rollers (which are again illustrated at 16/18) and can again include the take up roller 22 but dispense with the additional and intermediate counter direction roller 20 to avoid unnecessary bending of the veneer during the extrusion process), along with extruding the polymer 15 in order to create a further variant (see again alternate versions including either of incised sheets, panels or boards 57 or, alternately, the finished article being produced as a wound roll 58 of any of a structural, insulation or decorative article.

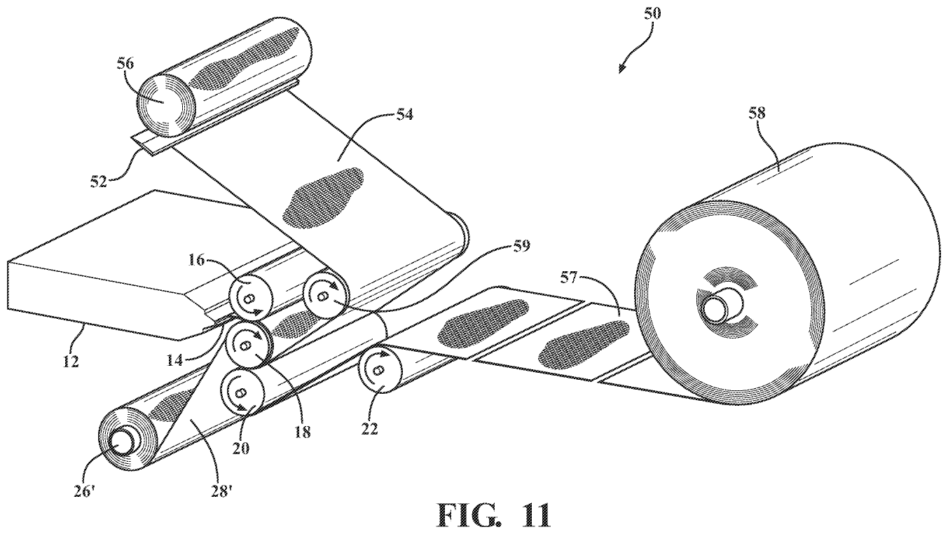

FIG. 11 is an illustration similar to FIG. 10 and depicting an alternate roller feeding orientation of the rotating log or stem roll for creating the article which again can be provided in either sheet or finished wound or roll form 58. This includes the addition of an offset roller 59 which is positioned offset from the first pair of pinch rollers 16/18 on a side opposite that the width injection die 12 for receiving and reverse directing the blade incised layer 54, with the redirected layer 54 being fed between the roller 18 and reverse direction roller 20 in combination with the natural fiber or other fibrous layer underside backing 28′.

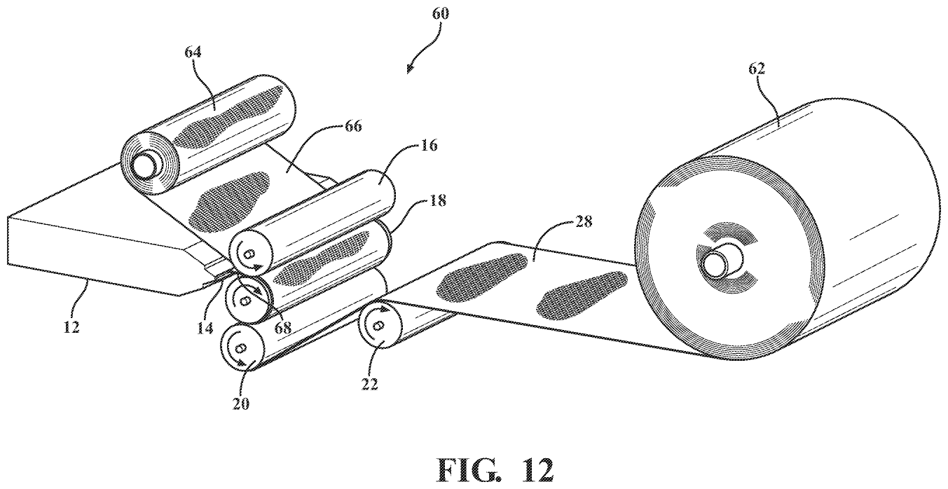

FIG. 12 is an illustration generally shown at 60 of a further variant of an extrusion process as compared to FIG. 1, for producing a continuous combination burlap/polymer sheet and which can be either sectioned into individual sheets or wound into a roll/coil form 62. A similar arrangement of extrusion die 12 and nozzle 14 as shown in FIG. 1 is again depicted, as are the first pair of upper 16 and lower 18 pinch rollers which are positioned forwardly and in relatively close proximity to the width extending nozzle 14 of the cross head injection die. Also again shown is further reverse direction roller 20 located below the lower roller 18 for redirecting the extruded article to the further downstream roller 22.

The outer ply material is again depicted as roll 64 which can include any of the previous materials previously described and from which a continuous sheet 66 is unwound and passed between the pinch rollers 16/18 in combination with the continuous polymer extrusion (see at 68). Without limitation, either the take-up roller 22 or any downstream location can include an incising knife or like operation for optionally sectioning the formed sheet article into specified lengths.

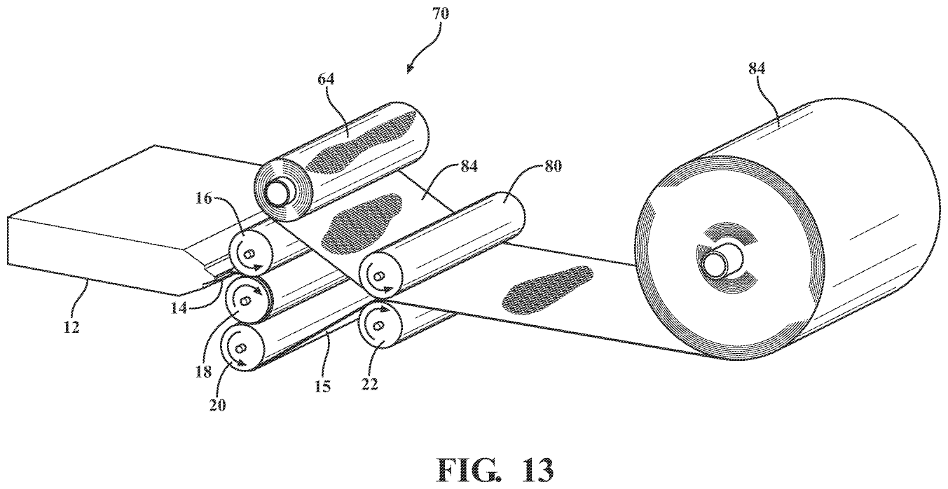

FIG. 13 presents a further alternate illustration, generally at 70 and showing a suitable outer fibrous (not limited to burlap or any other outer layer as previously described) applied onto the polymer extrusion downstream from the die. This includes the placement of an additional upper pinch die 80 defining, in combination with the lower die previously referenced at 22, a second pair of pinch dies downstream from the first pair of pinch dies 16/18. The finished article can then be sectioned into individual sheets or, as shown, wound into a finish reel or roll 84.

As further shown, the polymer extrusion (see at 15) is initially formed in passage through the first pair of pinch dies 16/18. Following the first pair of pinch dies, a separate roll material 64 is positioned to unwind a sheet 66 of any fibrous, mat or other material (not limited to any of those previously described) and which is introduced into the polymer extrusion at a downstream location from the first pair of pinch dies 16/18 at a location which enters the second or downstream pair of pinch dies 80/22. Following the second pair of upper and lower pinch dies 80/22, the formed article, board, panel, sheet, board, etc., is again either sectioned into sheets or, depending upon its relative bend-ability, can be wound into a roll/coil form as further shown at 84.

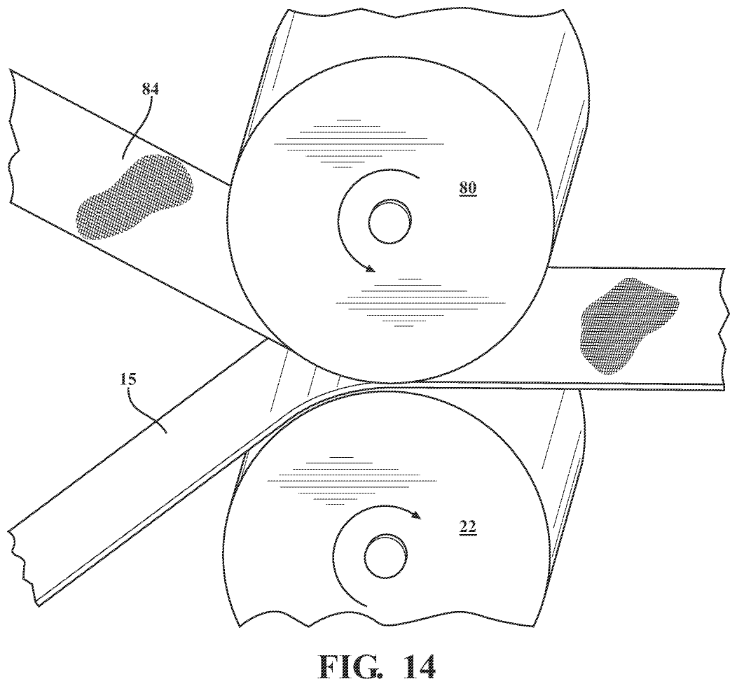

FIG. 14 is an enlarged view of the extrusion die according to FIG. 13 and depicting an optional heating of the upper roller 80 in FIG. 13, this being accomplished with the use of any suitable technology, for providing for flash melting of the previously extruded polymer (such as which may have previously cooled sufficiently following initial extrusion in order to have hardened to a degree). In this manner, penetration of the previously extruded polymer into the applied fibrous or other layer by the controlled action of the pinch rollers 80/22 (such as which can be adjusted as needed in terms of temperature, spacing, etc.,) is maintained according to the desired properties of the end product.

Beyond the reheat operation of FIG. 5, the present invention also contemplates and is compatible or complimentary with other widely used method for increasing adhesion to polymers/plastics. In a non-limiting instances, this can include such as surface preparation/treatment to activate the polymer substrate surface to increase its surface energy such as from plasma treatment, UV curable formulations, or other treatments and applications.

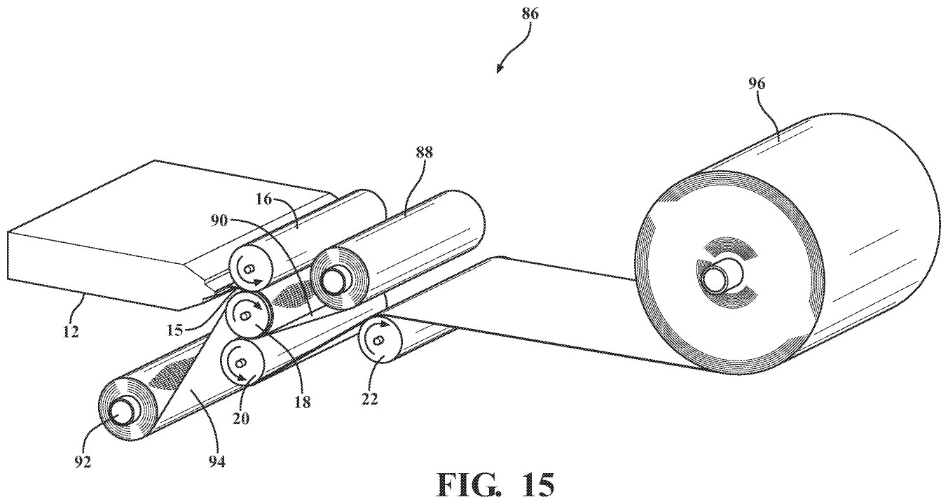

FIG. 15 is an illustration of a further embodiment, at 86, of the present invention and depicting each an outer material roll 88 from which is unwound an outer layer 90, along with an inner material roll 92 from which is unwound an inner layer 94. The arrangement of tiered pinch rollers (upper pair 16/18 and lower reverse roller 20) is repeated, along with the downstream take up roller 22. As previously described, the outer material can include any which is sensitive to high temperatures, not limited to a vinyl or the like, and which can be inserted into the inner roll and as shown fed between pinch rollers 18/20. The inner unwound layer 94 from inner roll 92 is fed against an underside of the polymer extrusion within the first pair of pinch rollers 16/18. The unwound outer layer 90 from the outer material roll 88 simultaneously fed between the lower pinch roller 18 and the reverse roller 20 in a fashion that is overlays the inner layer 94, this prior to being solidified and either sectioned or wound into a finish roll 96.

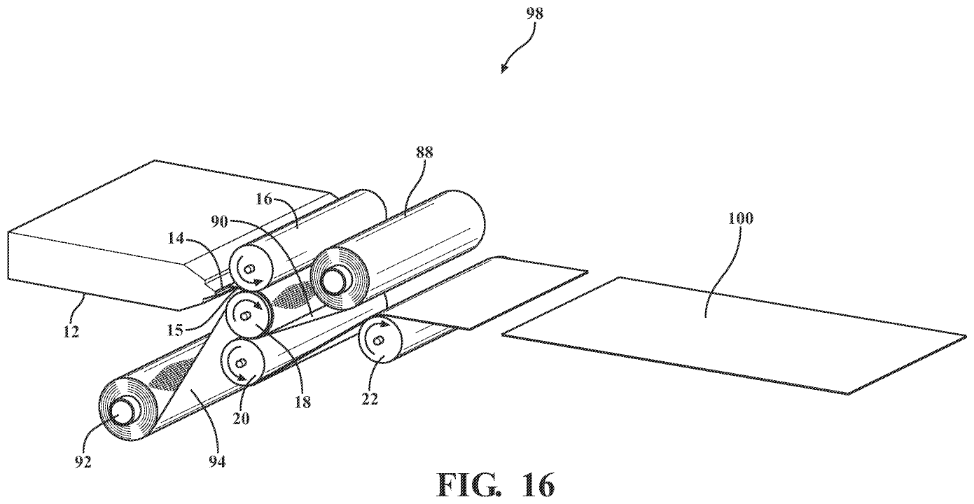

FIG. 16 is a rotated view, at 98, of the process depicted in FIG. 15 and which better illustrates an alternate application for producing any of a polymer extruded, sheet, board or panel article 100 having a burlap or fibrous-backed non-finished (B side) surface in combination with a finished (A side) surface and which can be produced into rolls or cut into desired dimensioned sheets. As described, the sheets, panels boards or other articles can be produced with sheeting/board lengths in either of a traverse extruding machine direction (wider extrusion line) or machine direction (narrower extrusion line). The various embodiments described herein can also produce any sheet, panel, roll or board article having any number of layers, including a single layer plus substrate versus dual layer plus substrate.

As further previously described, the formation processes described herein facilitate the bonding of a heated semi-molten polymer material with any separately applied layer of material, including any fibrous, mat, scrim, hemp or other material not limited to those described herein. The bonding process is again facilitated by the pinch rollers and which, in instances, can operate without the need for separate adhesives. To this end, non-adhesive lamination of the layers is facilitated in certain instances where the structure of the polymer is amorphous, and by which the molecules at the surface of the polymer tend to be loosely packed, in a semi-crystalline configuration.

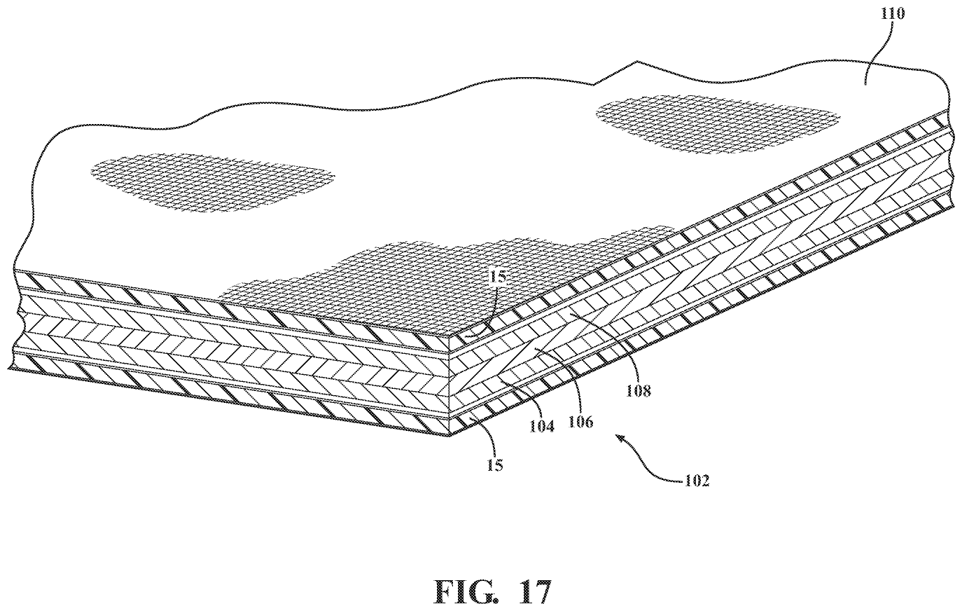

FIG. 17 is an illustration of a structural article 102 created by any process described herein and forming a wood core from a plurality of sheets of wood material, see at 104, 106, 108 such as bonded to plywood of any grade. A pair of upper and lower extruded polymer layers (both at 15) are again shown are applied on opposite sides of the sandwiched layers 104/106/108. Further illustrated is an upper most fibrous or other layer 110 and a lower weatherproof material (this can include the lower extruded layer 15 or can reference an additional laminated layer (not shown).

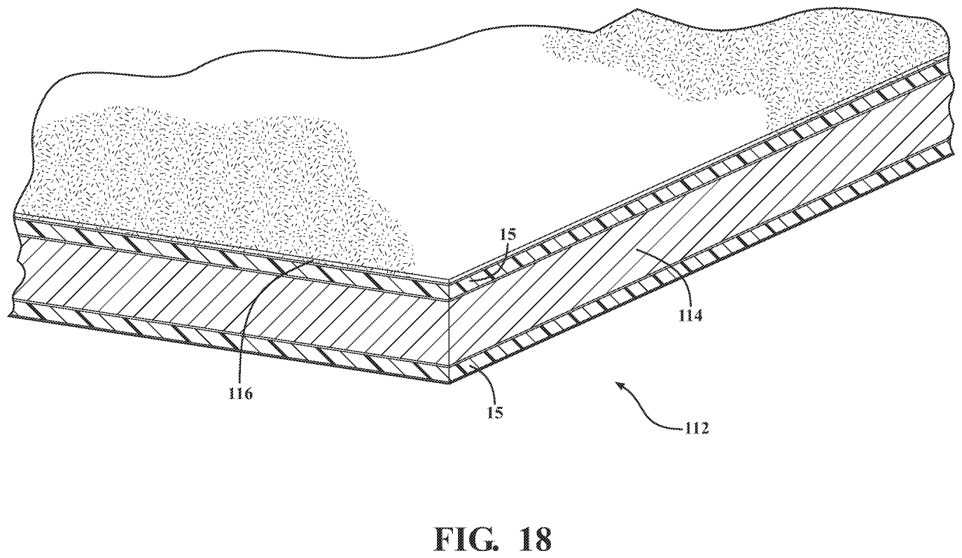

FIG. 18 is a similar illustration to FIG. 17 and depicting a further finished structural article 112 constructed from an alternate wood core 114 formed from any of medium density fiberboard (MDF), oriented strand board (OSB), sawdust with gypsum sheeting plywood, sanded plywood, and other such underlayments. Upper and lower extruded polymer layers 15 can again be formed on opposite sides of the core 114, with an uppermost pressed insulating or cushioned layer (e.g. carpet) 116 formed into a top surface of the article.

With reference to FIG. 19, an illustration is generally referenced at 200 of an extrusion process for forming a multi-layer article according to a further preferred embodiment of the present inventions. This includes the provision of a width extending die 202 having a narrowed forward nozzle 204 and such as which can be part of a cross head die arrangement which is supplied by a separate source of a heated and flowable polymer not limited to a polyurethane, polypropylene or other composite material, and which (as previously described in the preceding embodiment) can further include a suitable network of conduits lines and heaters for preparing and delivering the extruded material in a desired continuous and nozzle injection profile.

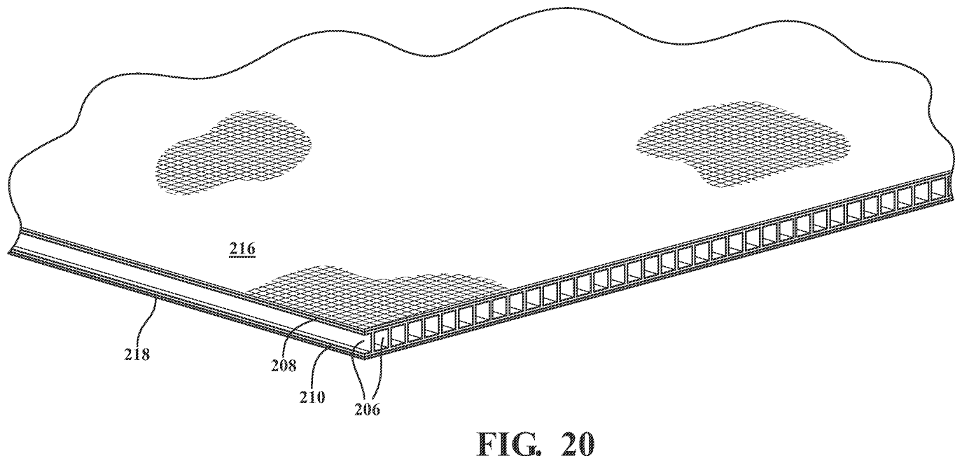

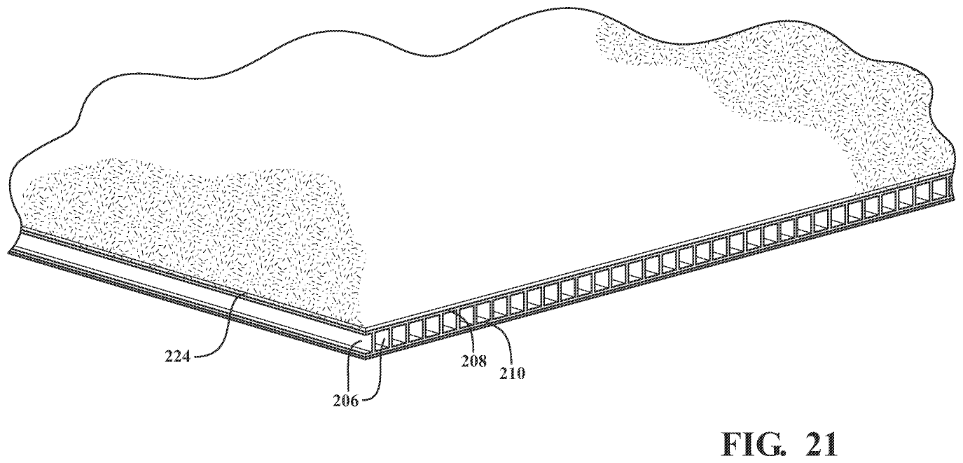

As is shown in better detail with reference to FIG. 20 and each of succeeding views FIGS. 21-23, the cross head die is configured to produce an article having a structurally rigid thermoplastic profile exhibiting a ribbed or other hollowed interior profile (this in contrast to the continuous sheet ply material 15 in the preceding embodiments). This is further depicted by spaced apart vertical support ribs 206 which separate upper 208 and lower 210 layers so as to define a plurality of hollow axial extending interior spaces or gaps.

Referencing again FIG. 19, and without limitation, the cross head and width extending die 202 can incorporate any combination of heaters and thermocouples (not shown) for managing the extrusion formation of the cross sectional profile of the polymerized material with the interior rib profile for producing a panel or board article exhibiting superior properties of strength combined with lighter weight. Also not shown are any arrangement of cooling tanks or chillers as are known in the technical art and which can be utilized to assist in the formation of the three-dimensional extruded polymer.

Any arrangement of individual and spindle supported rotating pinch rollers are again depicted as a pair of upper 212 and lower 214 rollers in FIG. 19 and which are positioned forwardly and in relatively close proximity to the width extending nozzle 204 of the cross head injection die 202. Without limitation, any combination of rollers (including both rotational powered and idled/free rotating) can be provided and such as which can include additional reverse direction rollers, such as located below the lower roller 214, and/or additional and downstream located rollers for assisting in post formation sectioning, stacking or other operations for producing individual panels or boards of desired length dimension.

A pair of further ply materials are shown at 216 and 218 and are likewise spindle mounted, see as shown at 220 for lower positioned roll 222 from which the unwound ply material 218 is drawn. The ply materials 216 and 218 are unwound approximate to the location of the cross head die nozzle 204 and so that, in combination with the appropriately sized and positioned rollers 212 and 214, again provides for formation of a structural, insulation or decorative article exhibiting the desired width and cross sectional properties. This again can include the material properties of the flowable polymerized material being calibrated through the use of thermocouples and site specific heaters (not shown) to allow the die 202 and nozzle 204 to extrude a steady sheet of material which is sufficiently solidified to maintain its dimensional characteristics while being pressed by the rollers 212/214 in order to fuse and embed within the matrix composition of the upper and lower unwound sheets 216/218 and to solidify into an integrated sheet product having desired properties of rigidity.

The ply materials 216/218 can include any coarse material such as a burlap, muslin or canvas for pressing the material into the molten polymer by the rollers 212 and 214, with roller 212 rotating counter clockwise as shown and opposing roller 214 rotating clockwise a close separation distance to force the molten extruded polymer into the upper 216 and lower 218 unwound ply sheets. In this manner, the extrusion process creates a structural, insulation or decorative article with the coarsened sheets embedded with both upper and lower surfaces of the extruded polymer and without the need for separate adhesives for producing a resulting sheet (such as which can be incised into individual sections in a downstream operation, such exhibiting any desired combination of stiffness, smooth polymer and fibrous organic qualities.

FIG. 21 is an illustration similar to FIG. 20 and showing a substitute upper ply material 224 applied to the extruded upper surface 208 of the three dimensional formed thermoplastic, such as which can be provided as any of an organic or inorganic material not limited to a carpet, liner, or other acoustic material. Upon extrusion formation, the carpet, liner or other acoustic material layer 224 embeds within the polymerized layer to provide any desired natural material qualities to the finished panel or board.

Without limitation, the organic or inorganic material can include any fibrous material incorporating a variety of organic or synthetic materials and which can be treated with additives or other agents for providing fire retardant capabilities, along with the use of blowing agents, varying stiffness, colors, anti-microbial properties or post production wolmanizing/pressure treating operations. As further described, the spacing and construction of the stacked and opposing arrayed rollers 212/214 is such that the fibrous material layers can be applied to either or both exterior surfaces of the polymerized material and are either pressed deeply into the extruded polymer (again defined by non-limiting representation as including vertical ribs 206 separating upper 208 and lower 210 layers) by the pinch rollers in order to create a mild organic texture or, alternatively, the positioning of the rollers can be adjustable for lightly pressing the polymer for producing a more natural finish.

The present invention also envisions the use of any other polymers and/or other additive or components or the like incorporated into the extruded composition, such envisioned to provide a range of qualities associated with one or more of stiffness, flexibility, weight, and the like. It is further envisioned that the article can be produced from entirely recyclable materials and can in turn be recyclable once it's given use application is exhausted.

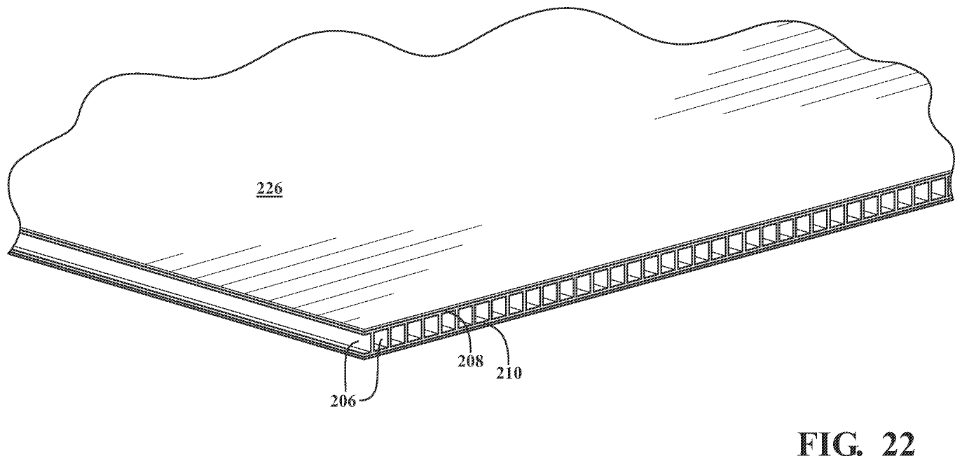

FIG. 22 is a further illustration similar to FIG. 20 and showing a substitute upper play material provided as any of a film, poly spun, vinyl fabric, cloth laminate, cross-linked foam laminate, scrim, weaving, mats, mesh or wallpaper 226 such as depicting an exposed finished side of the film, poly spun, vinyl fabric, cloth laminate, cross-linked foam laminate, scrim, weaving, mats or mesh in combination with an opposite adhering side for securing to the polymerized extruded material. Embedding of the outer ply material is again facilitated by pressure or forced bleed-through of the polymerized extrusion and without the requirement of adhesives or initial pressure application processes.

Any of the organic or inorganic outer applied layers, not limited to those depicted herein included at 224 in FIG. 21, can include a finished exterior surface and a natural fiber backed inner surface bonded to the inner extruded thermoplastic. By non-limiting application, the finished carpet/exterior side can provide the article with a natural look and feel, this in combination with a natural fiber underside backing for providing effective adherence between the layers in response only to the exerted pressure of the rollers which force the polymerized extruded layer into the gaps or crevices within the outer layers of the organic material for providing effective bonding and without the need for separate adhesives or any post formation compression operations.

A list of films/textiles/laminates can include, without limitation, non-woven polymers (polyester, polypropylene, rayon, or other blends), unbroken loop polymers (nylon, polyester), brushed polyester, woven or weft insert scrim, poly/cotton woven materials. Other films include any of thermoplastic polymers, flexible PVC, rigid PVC, polypropylene (PP, homopolymer, copolymer), polyethylene (LDPE, LLDPE, HDPE), olefin elastomers (TPO, POE, Metallocene), ethylene vinyl acetate (EVA), polyurethane (Ether or Ester) TPU, polyurethane (aliphatic) TPU, acrylic (impact modified) PMMA, acrylic (UV screening) PMMa, acrylonitrile butadiene styrene (ABS), bio-based (poly lactic acid) PLA, co-polyester PETG, PCTG, polyester elastomer (COPE), polycarbonate (PC) and Fiberglass Reinforced Plastic (FRP). Additional film substrates can include, again without limitation, any of PVC, PE, PP, EVA or TPU.

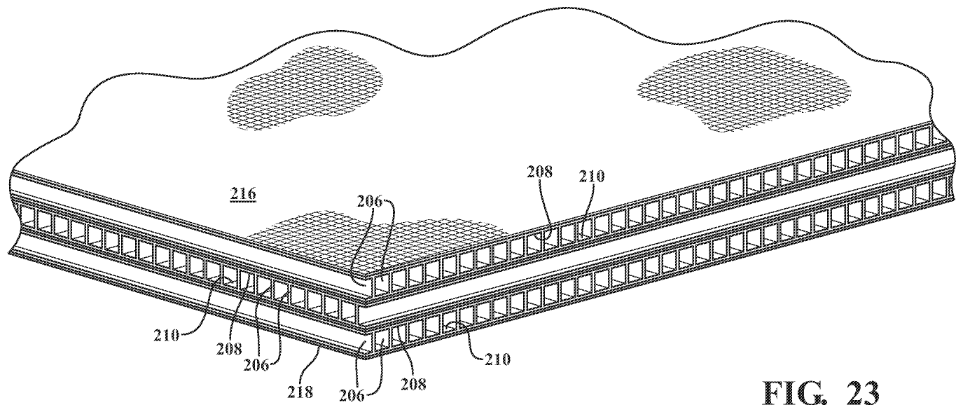

FIG. 23 is a variant of FIG. 20 and depicting a post formation operation in which a plurality of individual extruded components such as depicted in FIG. 20 are stacked and subsequently pressure and heat treated to bond them together in order to create a structural, insulation or decorative article exhibiting any desired thickness and to provide additional structural, insulation or decorative applications not limited to gluing, nailing, screwing, stapling, saw cutting or drilling. As is known, polymer compositions are typically difficult or expensive to bond with other materials. The post formation pressure bonding step takes advantage of the ability of the extruded material layers to be forced (or bleed through) the alternating outer canvas or other coarser layers during the subsequent pressure formation operation and in order to create a board material having a given material thickness suitable for providing many of the qualities similar to wood such that it can be easily and inexpensively fabricated by any of gluing, nailing, screwing, stapling, sawing/incising or drilling in a similar fashion as conventional wooden members.

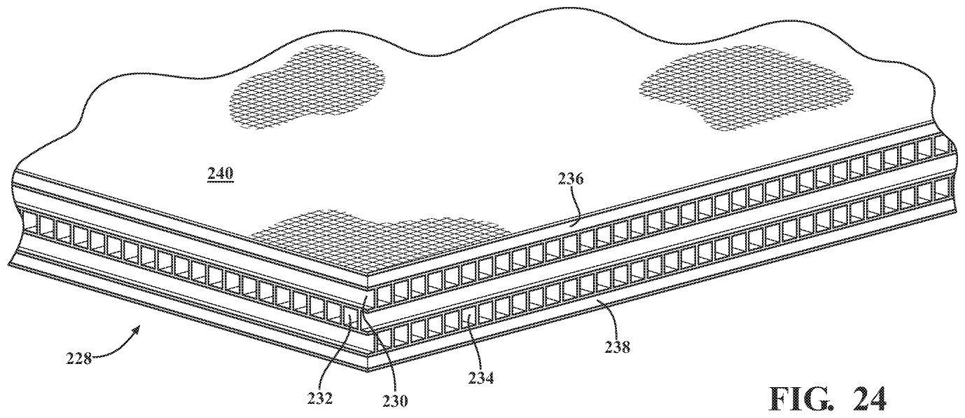

Proceeding to FIG. 24, an illustration is generally shown at 228 of an article produced from multiple individual extruded polymeric corrugated sheets, see as shown at 230, 232 and 234 and each further defined as having hollowed interior locations. As shown, the corrugated profiles associated with each of the sheets 230/232/234 are arranged in successive crosswise arrayed fashion. Additional solid extruded polymeric sheets (see upper at 236 and lower 238) can optionally be concurrently extruded and which can be bonded in sandwiched fashion to the exterior sides of the uppermost 230 and lowermost 234 corrugated sheets, this in order to form a durable, lightweight rigid panel or board.

Without limitation, the corrugated 230/232/234 and solid 236/238 sheets can be individually or concurrently extruded according. Without further limitation, the individual extruded sheets can be placed in a press stack or the like (not shown) and compressed using any combination of heat, pressure (with or without the use of additional adhesives) to form the completed article. As further shown, any surface sheet (see at 240) not limited to any type or variety previously described, can be bonded to the substrate panel 236 and for use in any type of laminated or non-laminated sheeting, flooring, walls, ceiling, decorative applications, adhesive bonding, welding or mechanical fastening.

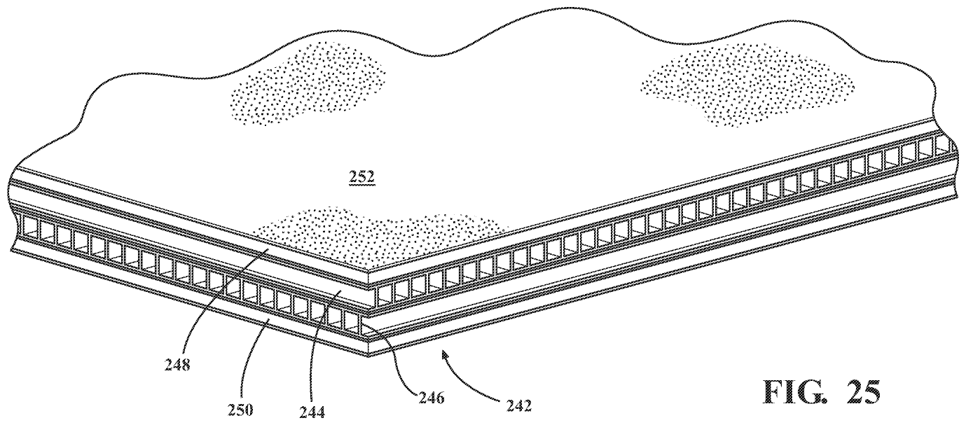

FIG. 25 is an illustration of a further article, generally at 242, similar to FIG. 24, and again produced from multiple individual extruded corrugated or otherwise three dimensional sheets, shown at 244 and 246 with hollow interior locations in crosswise arrayed fashion, and further exhibiting upper 248 and lower 250 solid sheets. A further surface sheet 252 includes any organic, synthetic, fiber or fabric materials not limited to those previously described bonded to any of the individual extruded plies (such as again at 248 and 250), such further including bonded substrates which can be added in either offline or secondary operations and for use in any type of laminated or non-laminated sheeting, flooring, walls, ceiling, decorative applications, adhesive bonding, welding or mechanical fastening. Although not shown, a similar surface sheet can be adhered to a bottom facing surface of either article 228 (FIG. 24) or 242 (FIG. 25).

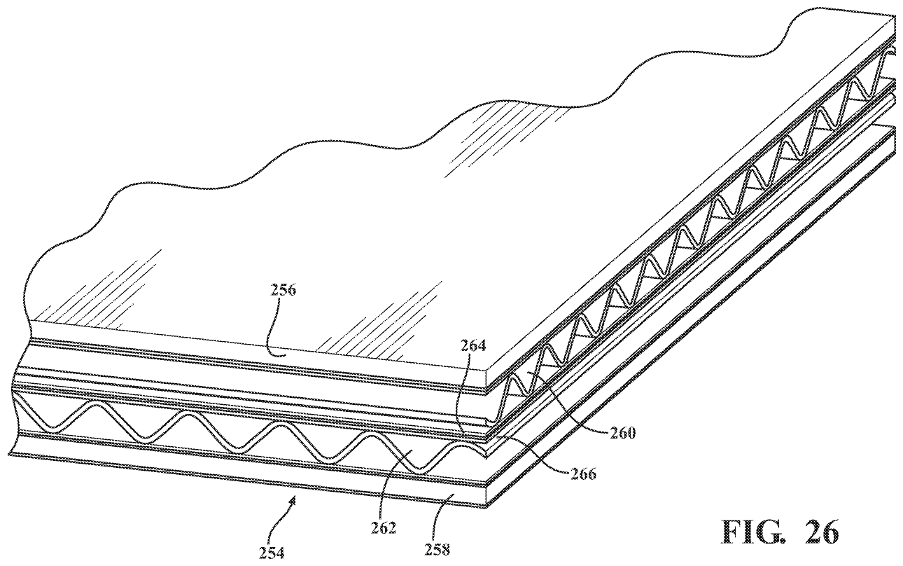

Proceeding to FIG. 26, an illustration is provided at 254 of a further structural multi-ply article including any arrangement of extruded plastic/polymeric sheets (see upper 256 and lower 258), such as which can be bonded to any number of layers of corrugate or other corrugated sheet materials. As shown, this can include corrugated sheet patterns 260 and 262 (this not limited to paperboard or other rigid or semi-rigid fibrous material, and which is arranged in sandwiching fashion about one or more central corrugate layers (at 264 and 266), and about which the extruded plastic layers 256/258 are formed and for use in any of sheeting, flooring, walls, ceiling, decorative applications, adhesive bonding, welding or mechanical fastening applications. The outer sheets (such as the polymerized material at 256 and 258) can be produced either with or without any additional outer layer, depending upon the desired application and in the instances of achieving a smooth, non slip characteristic with high surface friction and weatherproof finish.

Additional envisioned variants of the corrugate material also contemplate any ply material (not shown) which mixes a wood core including any hardwood/plywood, medium density fiberboard (MDF), oriented strand board (OSB), sawdust with gypsum, sheeting plywood, sanded plywood, or other underlayments, such again combined with one or more corrugated outer layers to create a sandwich composite article.

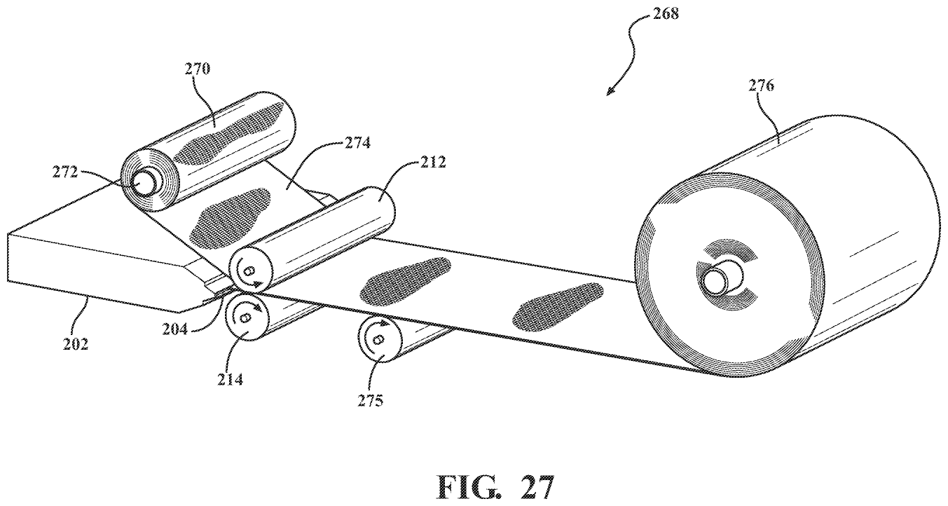

FIG. 27 is an illustration, generally at 268, of an extrusion process for producing a continuous combination fibrous/polymer sheet according to a further variant. An extrusion die is again shown at 202 and includes an injection nozzle 204 which is positioned for issuing a flowable polymer material between a pair proximately located pinch dies (again at 212/214).

A roll of a material 270 is depicted supported on a spindle 272 arranged in proximity to the injection nozzle 204. An unwound layer 274 of the material (compare to as shown at 216 in FIG. 19 and which without limitation can include a fibrous or other material) is fed between the pinch dies 212/214 along with the flowable polymer, a further take up roller shown at 275 for redirecting the finished article either sectioned into individual sheets (such as via an incising or sectioning operation) or, as further shown, wound into a roll/coil form (at 276), such article also envisioning any of dual or single lamination techniques associated with the feeding at the nip of the extrusion die. Without limitation, the invention contemplates any combination of heaters, thermocouples and sensors incorporated into the extrusion process and for achieving a desired extruded profile of the polymer flowable material and which can include any of smooth, corrugated or other hollow interior three dimensional profiles.

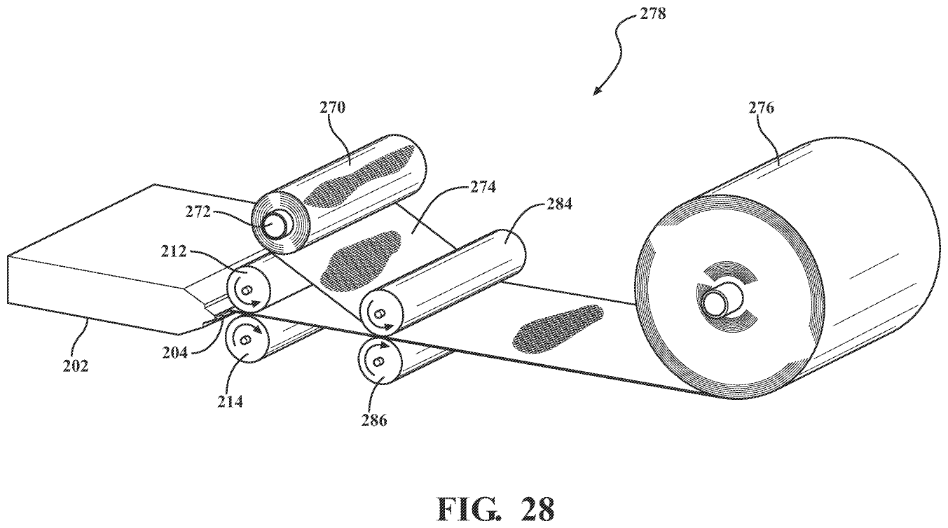

FIG. 28 presents a further variant, at 278, of an extrusion process for producing a continuous combination fibrous/polymer sheet which can be either sectioned into individual sheets or again wound into a roll/col form 280. As compared to FIG. 27, the upper material roll 270, (spindle supported at 272) with unwound layer 274, is reconfigured to overlay a previously extruded flowable polymer 282 to pass between a second downstream located pair of pinch rollers 284 and 286, and prior to be wound up into finished roll/coil 276. Such articles also envision without limitation any of dual or single lamination techniques associated with the feeding at a downline location along with the use of additional lamination pinch rolls associated with a reheat (or flash heat) post extrusion operation. The unwound layer 274 can also include any other material not limited to corrugate or other material and which provides for penetration of the polymer into the material or layer without excessive compression/crushing of the extruded shape.

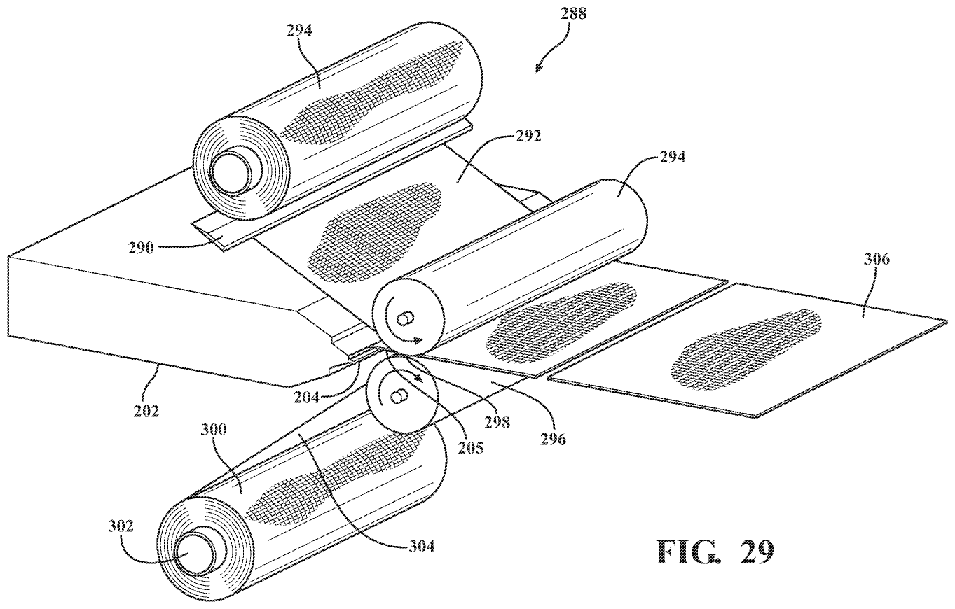

FIG. 29 is a still further alternate representation of a process and assembly, generally at 288 for forming any structural, insulation or decorative article and including a width arranged blade 290 for incising a wood veneer layer 292 of a given thickness from a rotating log or stem roll 294. As shown, the unwound layer 292 is sheared from the log or roll according to a given thickness and subsequently passed between a pair of pinch rollers 294 and 296 along with the extruded polymer.

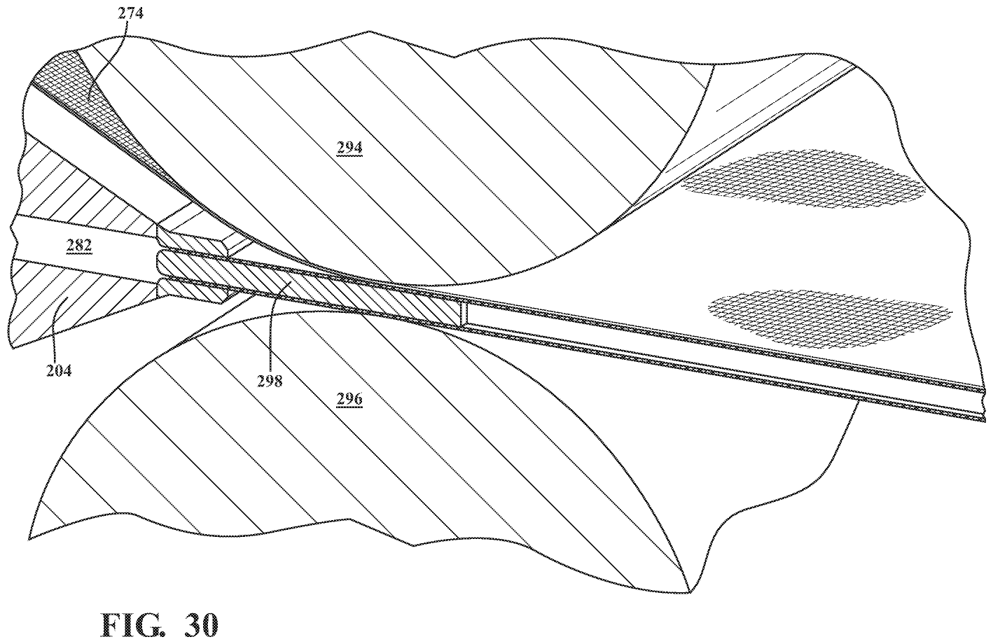

As will be further shown and described in FIG. 30, a die extension portion 298 passes a distance between the pinch rollers 294/296. A second roll of material 300 can be spindle supported at 302 and feeding a further unwound layer 304 into an underside of the die extension 308 opposite the upper wood veneer layer 292 for forming a completed article which can be either sectioned into individual sheets (see as shown at 306) or wound into a roll/reel (not shown in this view).

FIG. 30 is an enlarged view of the extrusion die according to either of FIGS. 28-29 and depicting the die extending (again at 298) into a roll area defined between the pinch rollers 294 and 296, in this instance facilitating the penetration of a burlap or other non-limiting fibrous material into the flowable polymer without excessive compression/crushing of the extruded shape. As previously described, the configuration of the die extension can provide the ability to form any solid or corrugated profile associated with the flowable polymer (again at 282).

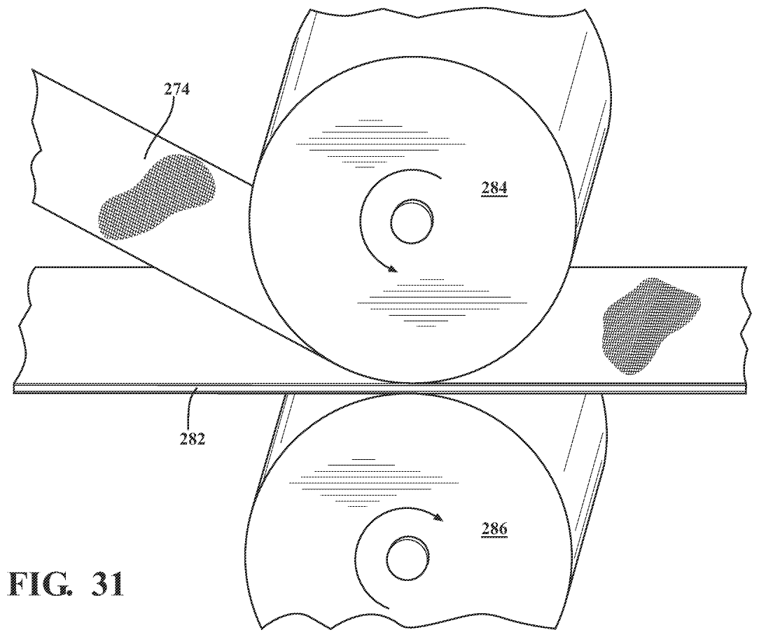

FIG. 31 presents an enlarged illustration of the interface between the second pair of pinch die rollers 294/296 shown in FIG. 29, such in combination with heating of the upper roller 286 for providing flash melting of the previously extruded polymeric layer (again at 282 and has sufficiently cooled following initial extrusion and passage between initial pinch rollers 212/214). The flash or reheat operation provides for penetration of the re-melted polymeric material into the burlap or other fibrous layer, again at 274 and not limited to any of those previously described.

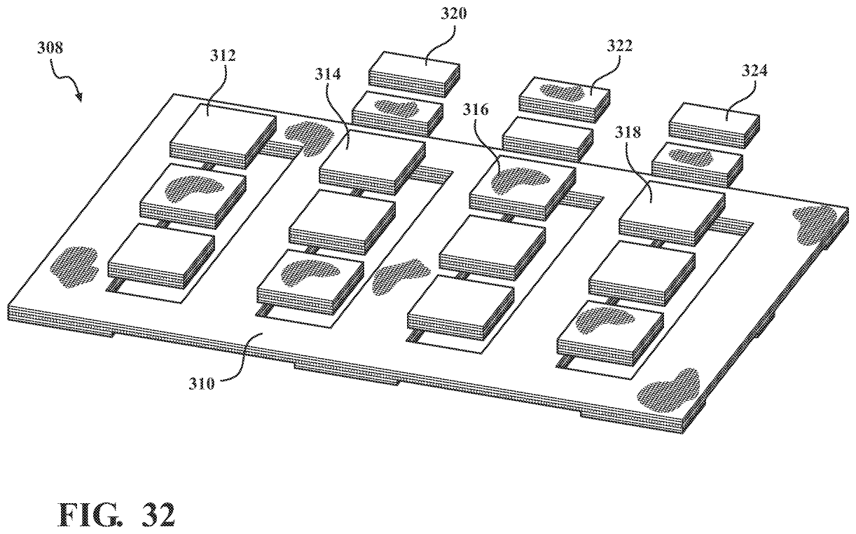

Proceeding to FIG. 32, an illustration is shown at 308 of a multi-ply panel or board which can be produced according to any forming process described herein. Following creation and incision in a desired sheet form, the rigid article is placed in a separate stamping, die-cut or laser cut operation (not shown) and stamped, die-cut or laser cut, such as in order to create a pallet deck 310 and cutout leg materials (see individual cutout sections 312, 314, 316, 318, 320 and 322) which as shown are removed from the deck and reused as height defining spacers between the upper and lower decks and to space apart the individual decks 310.

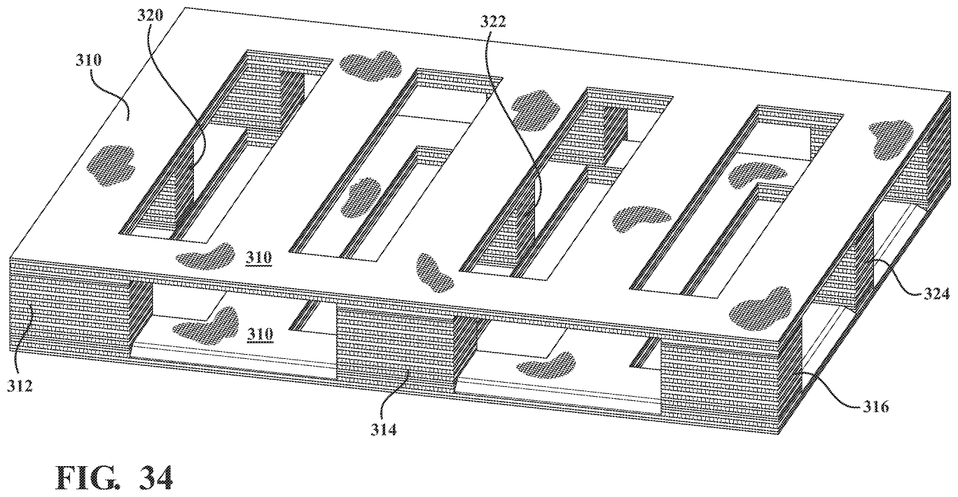

As further referenced in FIG. 32, the individual leg materials are bonded together between upper and lower decks (again at 310) in any plurality to build up the elevating feet or legs of the pallet. In one non-limiting embodiment, a pair of stamped, die-cut or laser cut pallet defining sheets as defined in FIG. 32 can be provided to create the completed pallet article of FIG. 34.

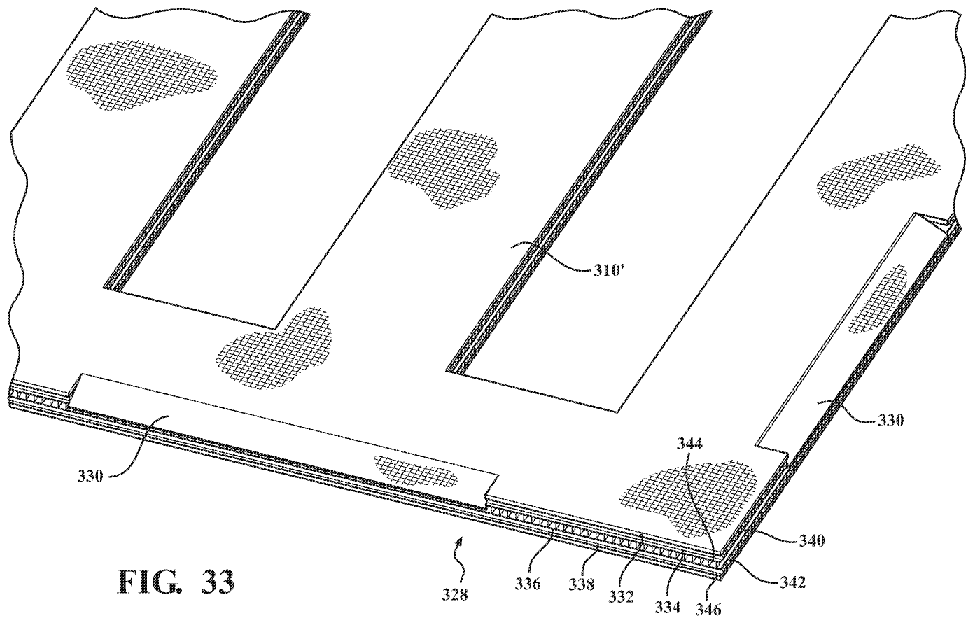

FIG. 33 is an illustration of a variant, generally at 328, of a variant 310′ of the pallet deck which can be heat staked, forming forklift ramp portions 330 for engaging the deck, panel or board. The formation process further envisions producing any rigid sheet configuration which can include any combination of extruded polymeric and adjoining rigid corrugate and/or wood core components as previously described in other variants. As further shown in FIG. 33, individual extruded polymeric sheets 332, 334, 336 and 338 are visible, along with corrugated layers 340 and 342 and additional flattened corrugated sheet or other material layers 344 and 346 which can be arranged in any desired layering or orientation.

Referencing again FIG. 34, the illustration of the stamped, die-cut or laser cut pallet illustrates the stamped, die-cut or laser cut leg materials (see again individual sectioned portions 312, 314, 316, 318, 320, 322 and 324) arranged in a plural stacked and bonded together fashion between the upper and lower decks 310. The use of surface materials such as fibrous layers optionally provided for efficient and inexpensive bonding with the polymerized flowable material, as well as providing a non slip surfacing characteristic similar to wood with high surface friction.

The pallet can also be produced utilizing in part or entirely any recycled materials, the pallet construction created further being nest-able or ventilated along with providing the optimal characteristics of light weight and durability. Use of such materials as impregnated burlap as described herein provides a non slip surface appearance similar to wood, again with high surface friction, and which provides for inexpensive and efficient bonding. Other features and characteristics of the pallet including providing the pallet with fire retardant capabilities, minimizing thermal expansion/contraction of the polymer/composite matrix, along with varying stiffness, colors, and anti-microbial properties.

Having described my invention, other and additional preferred embodiments will become apparent to those skilled in the art to which it pertains, and without deviating from the scope of the appended claims. This can include the individual sheets being produced with sheeting/board lengths in either of a transverse extruding machine direction (wider extrusion line) or a machine direction (narrower extrusion line).

The present invention also again contemplates the production of any of single layer and substrate articles, this in addition to post-formation fabrication techniques in which dual or other multiple layers and corresponding substrates are formed into any of sheets, panels, boards or rolls.

As also previously described, the invention also contemplates the application of separate adhesives, as well as non-adhesive versions for adhering the backing layer to the heated extrusion. In the latter instance of non-adhesive lamination, non-limiting applications can include the polymer being amorphous, with the molecules at the surface tending to be loosely packed, such as in a semi-crystalline configuration.

Other envisioned assemblies or processes again contemplate the use of the hot press/heat stake pinch rolls, such as following an initial cooling down of the polymer extruded material, and by which reheating of the polymer occurs simultaneous with use of the press laminate in order to secure/impregnate a fibrous, carpet or other acoustic material against the polymer.

The present invention is further understood to be compatible or complimentary with other widely used methods for increasing adhesion of the various backing or other non-polymer layers to the polymer extruded material, such including surface preparation/treatment operations for increasing surface energy such as from plasma treatment, UV curable formations and the like.

The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

I claim:

1. An assembly for forming a structural, insulating or decorative article as any of a roll, sheet, board or panel, said assembly comprising:
a width extending die for issuing a flowable polymeric material;
at least a pair of opposing and rotating pinch rollers for receiving therebetween the flowable material; and
a material roll simultaneously feeding a material layer between said rollers and against said flowable polymer material at a given pressure to cause said polymeric material to fuse and embed within the material layer.

2. The assembly of claim 1, said die further comprising an extrusion nozzle positioned between an inlet side of said pinch rollers for issuing the polymeric material in a continuous layer and at a width approximate to that of the unwound material layer, said nozzle being incorporated into an extruding machine for extruding said polymeric material having either of a solid or ribbed cross sectional profile.

3. The assembly of claim 1, said flowable polymer material further comprising a polyurethane, a polypropylene or other composite material.

4. The assembly of claim 1, said material roll further comprising a pair of material rolls, a first of said rolls being positioned above said width extending die and a second of said rolls being positioned below said width extending die.

5. The assembly of claim 1, said material roll further comprising a coarse material not limited to any of a fabric, cloth, burlap, mats, scrim, weaving, mesh, muslin or canvas.

6. The assembly of claim 1, said material roll further comprising an organic fabric or cloth treated with any combination of additives/fillers or blowing agents/chemical foaming agents to provide the structural, insulation or decorative article with any of fire retardant, antimicrobial or water-resistant capabilities, minimizing the thermal expansion/contraction of the polymer/composite matrix.

7. The assembly of claim 1, said material roll further comprising a film, poly spun, vinyl, fabric, coilable, Fiberglass Reinforced Plastic (FRP), cloth, laminate, crosslinked foam laminate, scrim, weaving, mats, mesh, pulp or paper.

8. The assembly of claim 1, said material roll further comprising any of a carpet, liner or acoustic dampening material, natural fiber or fibrous material for bonding to said polymeric material.

9. The assembly of claim 1, said material roll layer further comprising any fibrous material including any of jute/burlap, hemp, ramie, bamboo, cotton, linen, silk, sisal, piassava, alfa, bagasse, banana, pineapple, acacia, coconut, kenaf, wool, abaca, nettle, coir, cashmere, biuriti, ramie and further being either pressed into said flowable polymeric material by said pinch rollers in order to create a mild organic texture or, alternatively, lightly pressed for producing a more natural finish.

10. The invention of claim 1, said material roll further comprising a core formed from one or more sheets of a fibrous material including any of a medium density fiberboard (MDF), an oriented strand board (OSB), sawdust with gypsum sheeting plywood, or a sanded plywood.

11. The assembly of claim 1, said material roll further comprising a log or stem roll of a wood veneer layer which is progressively and continuously incised according to a determined thickness by a blade arranged in width engaging fashion against said roll.

12. The assembly of claim 1, further comprising a heat press for fusing a plurality of the articles in a post formation process.

13. The assembly of claim 1, said at least a pair of opposing and rotating pinch rollers further comprising each of a pair of rollers for receiving therebetween said flowable material and said unwound layer and a third roller positioned below a lower of said pair of rollers for redirecting said polymeric material and prior to delivering to a further take up roller preceding a post article formation and sectioning operation.

14. The assembly of claim 1, the flowable polymeric material further comprising an amorphous composition in which surface located molecules are loosely packed in a semi-crystalline configuration associated with a non-adhesive lamination process.

15. The assembly of claim 1, said unwound layer from said material roll further comprising one or more material layers fused with said polymeric material in a laminate construction.

16. The assembly of claim 1, said pair of opposing and rotating pinch rollers further comprising a first pair of pinch rollers for receiving therebetween the flowable material, a second downstream positioned pair of pinch rollers receiving and adhering or laminating the material roll layer against the polymeric material.

17. The assembly of claim 16, further comprising an upper selected die of said second pair of pinch rollers being heated for flash melting said polymeric material following its extrusion through said first pair of pinch rollers and to facilitate penetrating of said polymeric material into said material layer.

18. The assembly of claim 1, said material roll further comprising a first roll for providing a first unwound layer and a second roll for providing a second unwound layer, said first and second rolls positioned on opposite sides of said width extending extrusion die.

19. The assembly of claim 18, said first material roll further comprising an inner positioned roll for unwinding a temperature sensitive material, said second material roll further including an outer roll for subsequently laminating a second outer material over the temperature sensitive material.

20. The assembly of claim 1, said flowable polymeric material further comprising a surface preparation/treatment to activate a substrate surface to increase surface energy, said treatment not limited to any of plasma treatment, UV curable formulations, or other treatments and applications.

21. The assembly of claim 1, said material layer further comprising a multi-ply panel, said structural article further including a pallet produced from a pair of said panels defining upper and lower pallet decks.

22. The assembly of claim 22, further comprising each of said pallet decks being heat staked, forming forklift ramp portions for engaging said decks.

23. The assembly of claim 21, said multi-ply panel further comprising any combination of said polymeric material and adjoining rigid corrugate or wood core components.

24. The assembly of claim 23, said polymeric material further comprising a plurality of individual extruded polymeric sheets in combination with at least one corrugated layer and additional flattened corrugated sheet or other material layer.

25. The assembly of claim 25, said material roll further comprising a surface material bonding with said polymeric material for providing non slip with high surface friction.

26. The assembly of claim 21, further comprising said pallet being nest-able or ventilated along with providing the optimal characteristics of light weight and durability.

27. The assembly of claim 25, further comprising said pallet being fire retardant and exhibiting minimal thermal expansion/contraction of said polymeric and material layers, along with exhibiting varying stiffness, colors, and anti-microbial properties.

28. A process for forming a structural, insulating or decorative article as any of a roll, sheet, board or panel, said process comprising the steps of:
configuring a die with a width extending nozzle for issuing a flowable polymeric material;
arranging at least a pair of opposing and rotating pinch rollers at an outlet of said nozzle for receiving therebetween the flowable material; and
adhering the polymeric material to a separate material layer simultaneously unwound from a feed roll and fed between said pinch rollers at a given pressure to cause the polymeric material to fuse and embed within the unwound material layer.

29. The process of claim 28, further comprising the step of the nozzle extruding the polymeric material in either of a solid or ribbed cross sectional profile.

30. The process of claim 28, further comprising the steps of providing the material feed roll as a log or stem roll and further configuring a width arranged blade against the roll for progressively and continuously incising the unwound layer according to a determined thickness.

31. The process of claim 28, further comprising the step of configuring a heat press for fusing a plurality of the articles in a post formation process.

32. The process of claim 28, further comprising the step of the separate material layer being formed as a multi-ply panel, the structural article further including a pallet produced from a pair of said panels defining upper and lower pallet decks.

33. The process of claim 28, further comprising the step of a post-formation stamping, die-cutting or laser cutting process sectioning cutout materials from each of said decks, the individual materials subsequently being bonded together and positioned between said decks in any plurality to space apart said upper and lower decks.
